(19) United States
(12) Patent Application Publication
(10) Pub. No.: US 2025/0138308 A1
(43) Pub. Date: May 1, 2025

(54) OPTICAL SYSTEM AND DISPLAY DEVICE

(71) Applicant: SONY GROUP CORPORATION, TOKYO (JP)

(72) Inventors: ATSUHIRO HORI, TOKYO (JP); TOSHIFUMI YASUI, TOKYO (JP)

(21) Appl. No.: 18/834,917

(22) PCT Filed: Jan. 23, 2023
(86) PCT No.: PCT/JP2023/002970

§ 371 Date: Jul. 31, 2024

(30) Foreign Application Priority Data
Feb. 9, 2022 (JP) 2022-018982

(51) Int. Cl. G02B 27/00; G02B 7/02; G02B 27/28

(52) U.S. Cl. CPC G02B 27/0068; G02B 7/021; G02B 27/286

(57) ABSTRACT

To facilitate the correction of aberrations of lenses in an optical system. The optical system is used to observe an image displayed on an image display surface of a display element from an observation unit. The optical system includes a first lens group and a second lens group. The first lens group is provided with a transparent element having a first transflective surface, a first aspherical lens, and a second aspherical lens having a second transflective surface, which are arranged sequentially in order from the observation unit. The second transflective surface is formed on the side of the second aspherical lens with a positive refractive power facing the image display surface. The second lens group is arranged between the first lens group and the image display surface and is provided with at least one aspherical lens. The first aspherical lens has a higher absolute focal length than the second aspherical lens, and the first aspherical lens has a smaller Abbe number at a d-line than the second aspherical lens.

### FIELD

The present disclosure relates to an optical system and a display device.

### BACKGROUND

Display devices such as head-mounted displays (HMD) are being used to present augmented reality (AR) and virtual reality (VR) images to users. A display device that uses what is known as a triple-pass optical system has been developed for an optical system of such display devices. This triple-pass optical system folds back the optical path of an image from display elements twice using two reflecting surfaces. Such use of the triple-pass optical system makes it possible to make a display device thinner (see, e.g., Patent Literature 1).

### CITATION LIST

### Patent Literature

Patent Literature 1: JP 2020-030302 A

### SUMMARY

### Technical Problem

However, the above-mentioned conventional approach faces challenges in correcting chromatic aberration and other aberrations of lenses arranged in the optical path of the triple-pass optical system. Particularly, an optical system with a high angle of view, for example, an optical system with a total angle of view of 80 degrees or more, has a challenge in that it becomes difficult to correct chromatic aberration.

Hence, the present disclosure presents an optical system and a display device capable of easily correcting chromatic aberration of a lens.

### Solution to Problem

An optical system according to the present disclosure configured to observe an image displayed on an image display surface of a display element from an observation unit, includes: a first lens group provided with a transparent element having a first transflective surface, a first aspherical lens, and a second aspherical lens having a second transflective surface, which are arranged sequentially in order from the observation unit, the second transflective surface being formed on a side of the second aspherical lens with a positive refractive power facing the image display surface; and a second lens group arranged between the first lens group and the image display surface and provided with at least one aspherical lens, wherein the first aspherical lens has a higher absolute focal length than the second aspherical lens, and the first aspherical lens has a smaller Abbe number at a d-line than the second aspherical lens.

Further, a display device according to the present disclosure includes: a display element; and an optical system configured to observe an image displayed on an image display surface of the display element from an observation unit, wherein the optical system includes, a first lens group provided with a transparent element having a first transflective surface, a first aspherical lens, and a second aspherical lens having a second transflective surface, which are arranged sequentially in order from the observation unit, the second transflective surface being formed on a side of the second aspherical lens with a positive refractive power facing the image display surface; and a second lens group arranged between the first lens group and the image display surface and provided with at least one aspherical lens, wherein the first aspherical lens has a higher absolute focal length than the second aspherical lens, and the first aspherical lens has a smaller Abbe number at a d-line than the second aspherical lens.

### BRIEF DESCRIPTION OF DRAWINGS

FIG. 1 is a diagram illustrating an exemplary configuration of a display device according to a first embodiment of the present disclosure.

FIG. 2A is a diagram illustrating an exemplary configuration of a first aspherical lens according to the first embodiment of the present disclosure.

FIG. 2B is a diagram illustrating an exemplary configuration of the first aspherical lens according to the first embodiment of the present disclosure.

FIG. 3A is a diagram illustrating an example of diopter adjustment according to the first embodiment of the present disclosure.

FIG. 3B is a diagram illustrating an example of diopter adjustment according to the first embodiment of the present disclosure.

FIG. 3C is a diagram illustrating an example of diopter adjustment according to the first embodiment of the present disclosure.

FIG. 4A is a diagram illustrating an example of astigmatic aberration according to the first embodiment of the present disclosure.

FIG. 4B is a diagram illustrating an example of astigmatic aberration according to the first embodiment of the present disclosure.

FIG. 4C is a diagram illustrating an example of astigmatic aberration according to the first embodiment of the present disclosure.

FIG. 5 is a diagram illustrating an example of the light ray bending angle of a second lens group according to the first embodiment of the present disclosure.

FIG. 6 is a diagram illustrating an example of the shape of a lens according to the first embodiment of the present disclosure.

FIG. 7 is a diagram illustrating an example of the shape of a lens according to the first embodiment of the present disclosure.

FIG. 8A is a diagram illustrating an example of the resolution of an optical system according to the first embodiment of the present disclosure.

FIG. 8B is a diagram illustrating an example of the resolution of the optical system according to the first embodiment of the present disclosure.

FIG. 9A is a diagram illustrating an example of the resolution of the optical system according to the first embodiment of the present disclosure.

FIG. 9B is a diagram illustrating an example of the resolution of the optical system according to the first embodiment of the present disclosure.

FIG. 10 is a diagram illustrating an example of eyeball rotation according to an embodiment of the present disclosure.

FIG. 11 is a diagram illustrating an exemplary configuration of a display device according to a second embodiment of the present disclosure.

FIG. 12 is a diagram illustrating an exemplary configuration of a first aspherical lens according to the second embodiment of the present disclosure.

FIG. 13 is a diagram illustrating an example of the shape of a lens according to the second embodiment of the present disclosure.

FIG. 14 is a diagram illustrating an example of the shape of a lens according to the second embodiment of the present disclosure.

FIG. 15A is a diagram illustrating an example of the resolution of an optical system according to the second embodiment of the present disclosure.

FIG. 15B is a diagram illustrating an example of the resolution of the optical system according to the second embodiment of the present disclosure.

FIG. 16A is a diagram illustrating an example of the resolution of the optical system according to the second embodiment of the present disclosure.

FIG. 16B is a diagram illustrating an example of the resolution of the optical system according to the second embodiment of the present disclosure.

FIG. 17 is a diagram illustrating an exemplary configuration of a display device according to a third embodiment of the present disclosure.

FIG. 18 is a diagram illustrating an exemplary configuration of a first aspherical lens according to the third embodiment of the present disclosure.

FIG. 19 is a diagram illustrating an example of the shape of a lens according to the third embodiment of the present disclosure.

FIG. 20 is a diagram illustrating an example of the shape of a lens according to the third embodiment of the present disclosure.

FIG. 21A is a diagram illustrating an example of the resolution of an optical system according to the third embodiment of the present disclosure.

FIG. 21B is a diagram illustrating an example of the resolution of the optical system according to the third embodiment of the present disclosure.

FIG. 22A is a diagram illustrating an example of the resolution of the optical system according to the third embodiment of the present disclosure.

FIG. 22B is a diagram illustrating an example of the resolution of the optical system according to the third embodiment of the present disclosure.

FIG. 23 is a diagram illustrating an exemplary configuration of a display device according to a fourth embodiment of the present disclosure.

FIG. 24 is a diagram illustrating an exemplary configuration of a first aspherical lens according to the fourth embodiment of the present disclosure.

FIG. 25 is a diagram illustrating an example of the shape of a lens according to the fourth embodiment of the present disclosure.

FIG. 26 is a diagram illustrating an example of the shape of a lens according to the fourth embodiment of the present disclosure.

FIG. 27A is a diagram illustrating an example of the resolution of an optical system according to the fourth embodiment of the present disclosure.

FIG. 27B is a diagram illustrating an example of the resolution of the optical system according to the fourth embodiment of the present disclosure.

FIG. 28A is a diagram illustrating an example of the resolution of the optical system according to the fourth embodiment of the present disclosure.

FIG. 28B is a diagram illustrating an example of the resolution of the optical system according to the fourth embodiment of the present disclosure.

FIG. 29 is a diagram illustrating an exemplary configuration of a display device according to a fifth embodiment of the present disclosure.

FIG. 30 is a diagram illustrating an example of an optical path of an optical system according to the fifth embodiment of the present disclosure.

FIG. 31 is a diagram illustrating an exemplary configuration of a display device according to a sixth embodiment of the present disclosure.

FIG. 32 is a diagram illustrating an exemplary configuration of a first aspherical lens according to the sixth embodiment of the present disclosure.

FIG. 33 is a diagram illustrating an example of the shape of a lens according to the sixth embodiment of the present disclosure.

FIG. 34 is a diagram illustrating an example of the shape of a lens according to the sixth embodiment of the present disclosure.

FIG. 35A is a diagram illustrating an example of the resolution of an optical system according to the sixth embodiment of the present disclosure.

FIG. 35B is a diagram illustrating an example of the resolution of the optical system according to the sixth embodiment of the present disclosure.

FIG. 36 is a diagram illustrating an exemplary configuration of a display device according to a seventh embodiment of the present disclosure.

FIG. 37 is a diagram illustrating an exemplary configuration of a first aspherical lens according to the seventh embodiment of the present disclosure.

FIG. 38 is a diagram illustrating an example of the shape of a lens according to the seventh embodiment of the present disclosure.

FIG. 39 is a diagram illustrating an example of the shape of a lens according to the seventh embodiment of the present disclosure.

FIG. 40A is a diagram illustrating an example of the resolution of an optical system according to the seventh embodiment of the present disclosure.

FIG. 40B is a diagram illustrating an example of the resolution of the optical system according to the seventh embodiment of the present disclosure.

FIG. 41 is a diagram illustrating an exemplary configuration of a display device according to an eighth embodiment of the present disclosure.

### DESCRIPTION OF EMBODIMENTS

Embodiments of the present disclosure are now described in detail with reference to the drawings. The description will be given in the following order. Moreover, in the following embodiments, the same components are given the same reference numerals, and the repetitive descriptions will be omitted.
1. First Embodiment
2. Second Embodiment
3. Third Embodiment
4. Fourth Embodiment
5. Fifth Embodiment
6. Sixth Embodiment
7. Seventh Embodiment
8. Eighth Embodiment

### 1. First Embodiment

### [Configuration of Display Device]

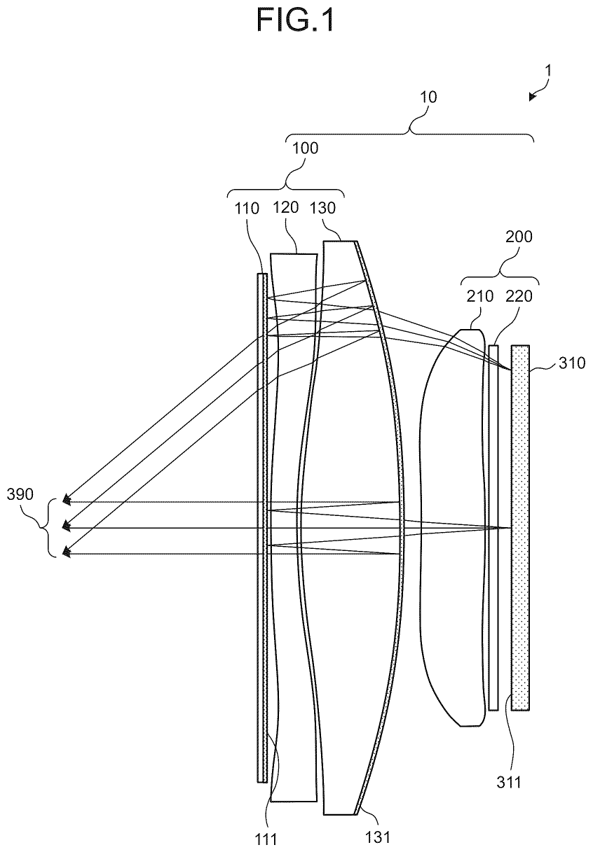

FIG. 1 is a diagram illustrating an exemplary configuration of a display device according to a first embodiment of the present disclosure. The depicted figure provides a cross-sectional view illustrating an exemplary configuration of the display device 1. The display device 1 is equipment that guides an image of a display element (such as a display element 310) to an observation unit (e.g., a user's eyeball) to allow the user to observe the image. The display device 1 in the depicted figure includes the display element 310 and an optical system 10. Moreover, an observation unit 390 is illustrated in the depicted figure. This observation unit 390 is a virtual plane, also called a pupil plane.

The display element 310 is used to display an image. This display element 310 can be configured by, for example, an organic light-emitting diode (OLED). The display element 310 displays an image on an image display surface 311. The light of the displayed image enters the optical system 10. Moreover, other elements, such as a liquid crystal display element, can also be applied to the display element 310.

The optical system 10 allows an optical image of an image displayed on the image display surface 311 of the display element 310 to be observed from the observation unit 390. The optical system 10 includes a first lens group 100 and a second lens group 200.

The first lens group 100 includes a transparent flat plate 110, a first aspherical lens 120, and a second aspherical lens 130. The transparent flat plate 110, the first aspherical lens 120, and the second aspherical lens 130 are arranged sequentially in this order from the observation unit 390 to the display element 310.

The transparent flat plate 110 is configured in a plate shape and transmits light emitted from the display element 310. This transparent flat plate 110 has a first transflective surface 111 arranged on its surface. This first transflective surface 111 allows a portion of the incident light to transmit through it while reflecting another portion of the incident light. The transparent flat plate 110 in the depicted figure represents an example of a first transflective surface 111 arranged on the side close to the display element 310. For example, it is possible to use a half mirror for the first transflective surface 111. Moreover, the transparent flat plate 110 is an example of a transparent element described in the claims.

The second aspherical lens 130 is an aspherical lens configured with positive refractive power. The second aspherical lens 130 has a second transflective surface 131 formed on the side facing the image display surface 311.

The first aspherical lens 120 is an aspherical lens arranged between the first transflective surface 111 of the transparent flat plate 110 and the second transflective surface 131 of the second aspherical lens 130. In addition, the first aspherical lens 120 in the depicted figure represents an example configured to have negative refractive power. The negative refractive power of the first aspherical lens 120 makes it possible to reduce the deterioration of chromatic aberration of magnification.

In addition, the first aspherical lens 120 can be configured such that, on the first surface, which is the side closer to the observation unit 390, there are at least two positions where the second derivative value of the sag amount with respect to the radial position equals the value “0”, and the value at its central portion is a positive value. Details of the shape of the first aspherical lens 120 will be described later.

The second lens group 200 is a lens group, which is arranged between the first lens group 100 and the image display surface 311 and includes at least one aspherical lens. The second lens group 200 in the depicted figure represents an example including an aspherical lens 210 and a transparent flat plate 220. Moreover, upon adjusting the diopter in the display device 1, the second lens group 200 and the display element 310 move together in the optical axis direction. Moreover, the transparent flat plate 220 is an example of a second transparent element described in the claims.

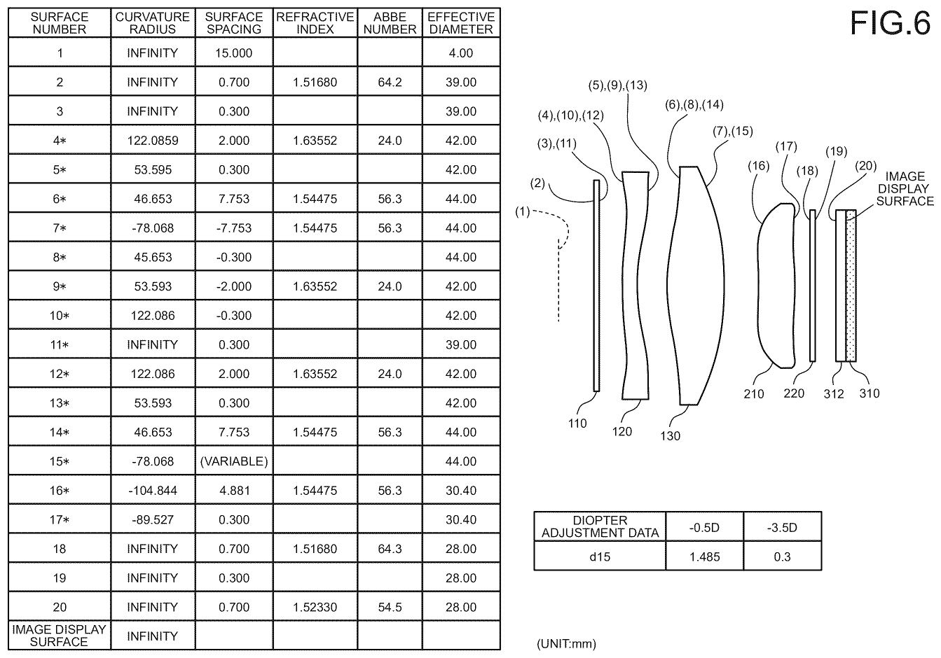

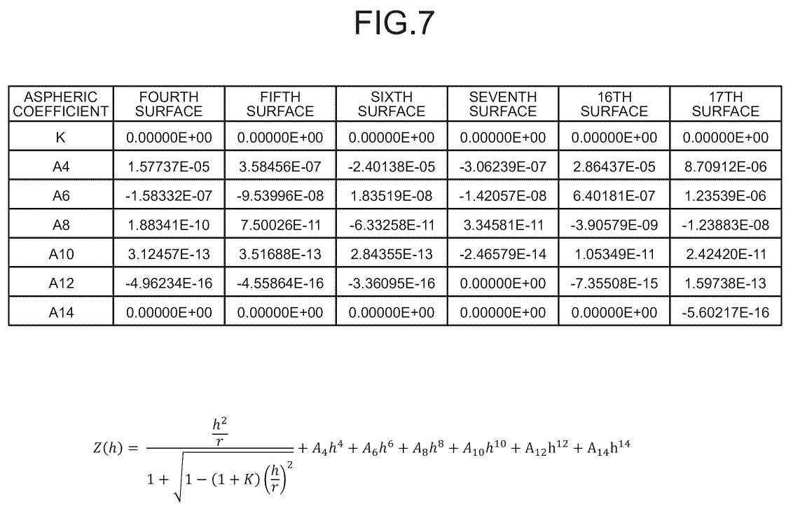

The shapes of the lenses of the first lens group 100 and the second lens group 200 will be described later with reference to FIGS. 6 and 7.

The arrows in the depicted figure represent light rays emitted from the image display surface 311 and transmitted through the optical system 10. As illustrated in the depicted figure, incident light rays are reflected by the first transflective surface 111 and the second transflective surface 131, respectively, and pass through the first aspherical lens 120 and the second aspherical lens 130 three times. This triple pass makes the optical system 10 thinner and smaller.

Furthermore, combining the first aspherical lens 120 with negative refractive power and the second aspherical lens 130 with positive refractive power makes it possible to easily adjust aberrations such as chromatic aberration.

Further, the first lens group 100 and the second lens group 200 can be configured to have a shape that satisfies the following conditional expression in the case where their respective focal lengths are denoted as f1 and f2:

$$- 0.6 < f 1 / f 2 < 0.4 \qquad ( 1 )$$

Satisfying this condition enables a modulation transfer function (MTF) to increase by 10% or more in two optical systems, each with a diopter difference of ±4D, under conditions where the eyeball rotation angle in each system is 30 degrees, and the spatial frequency is 80 lp/mm. The MTF will be described later. This configuration permits diopter adjustments without substantial modifications to the focal length of the entire optical system while maintaining the image surface properties.

### [Configuration of First Aspherical Lens]

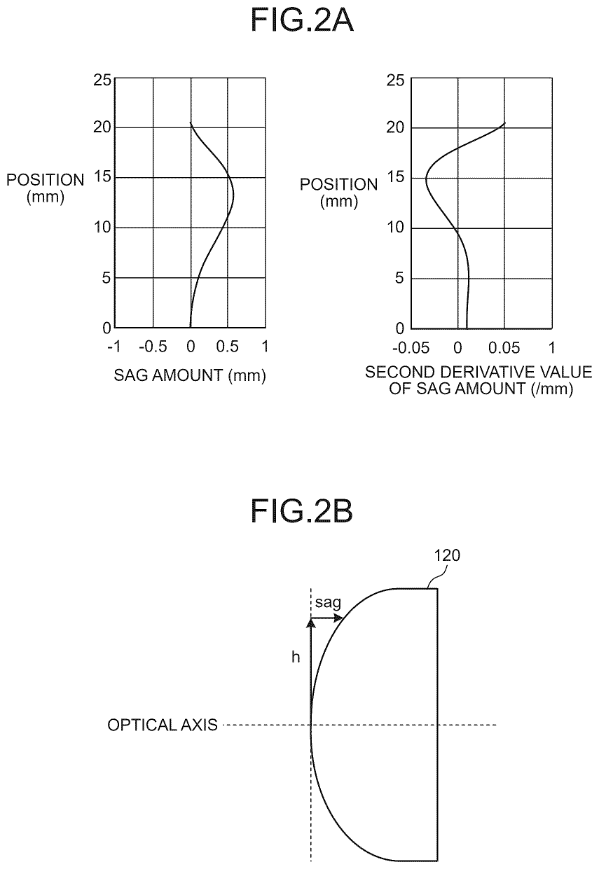

FIGS. 2A and 2B are diagrams illustrating an exemplary configuration of the first aspherical lens according to the first embodiment of the present disclosure. These figures are diagrams illustrating an exemplary configuration of the first aspherical lens 120.

FIG. 2A is a graph illustrating the sag amount on a first surface of the first aspherical lens 120. The sag amount is described using FIG. 2B. In the depicted figures, “sag” represents the sag amount. This sag amount is the distance from a virtual plane passing through the central portion of the first aspherical lens 120 to the surface (the first surface). In addition, the sag amount varies depending on a position h of the first aspherical lens 120.

The left view in FIG. 2A is a graph illustrating the relationship between position (h) and the sag amount, where the vertical axis represents position (h) and the horizontal axis represents sag amount (sag). In addition, the right view in FIG. 2A is a graph illustrating the relationship between the position (h) and the second derivative value of the sag amount, where the vertical axis represents the position (h), and the horizontal axis represents the second derivative value of the sag amount. As illustrated in the right view of FIG. 2A, there are two points on the first surface of the first aspherical lens 120 where the second derivative value of the sag amount equals zero (“0”), and the value at the central portion is positive. Employing such a configuration allows aberrations to be balanced. In particular, it is possible to improve chromatic aberration significantly, thereby enhancing the resolution of the optical system 10.

### [Adjustment of Diopter]

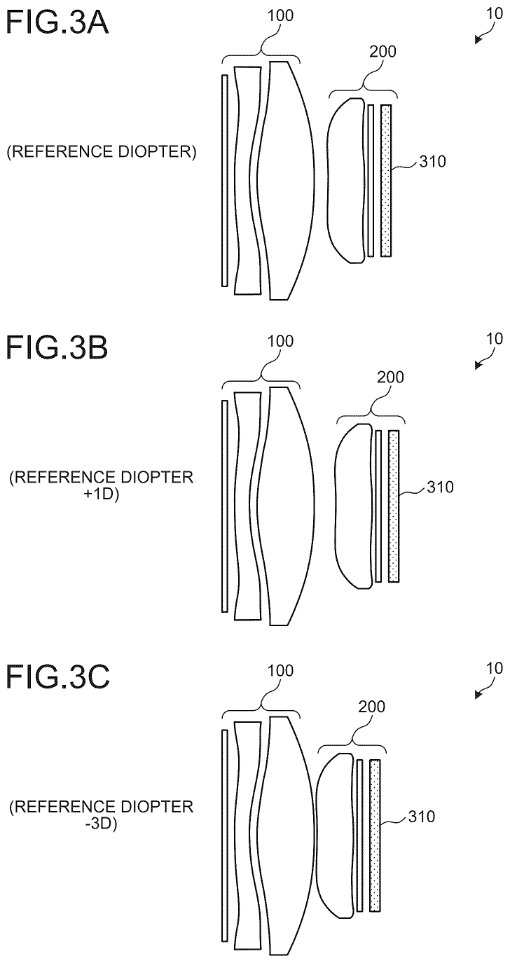

FIGS. 3A to 3C are diagrams illustrating an example of diopter adjustment according to the first embodiment of the present disclosure. These figures are diagrams illustrating an example of adjusting the diopter in the optical system 10. FIG. 3A illustrates an example of the reference diopter. In this case, the diopter (hereinafter referred to as D) is valued at “−0.5”. FIG. 3B illustrates an example of the case where the reference diopter is valued at +1D. In addition, FIG. 3C illustrates an example of the case where the reference diopter is valued at −3D. In this way, it is possible to adjust the diopter by fixing the position of the first lens group 100 and shifting the second lens group 200 and the display element 310 together back and forth in the optical axis direction.

### [Focal Length of Second Lens Group]

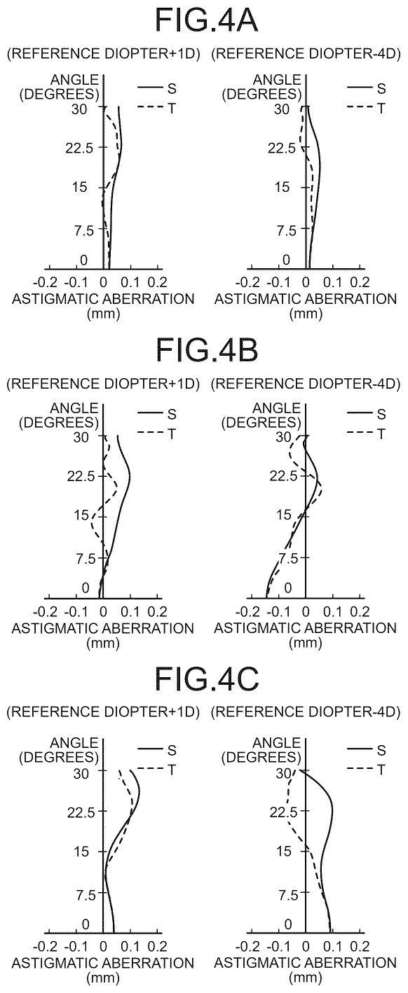

FIGS. 4A to 4C are diagrams illustrating an example of astigmatic aberration according to the first embodiment of the present disclosure. These figures are diagrams illustrating an example of astigmatic aberration and field curvature with respect to the eyeball rotation angle in the case where the focal length of the second lens group is changed. In these figures, the solid line graph represents the aberration of the sagittal image plane (denoted as “S”), and the dashed line graph represents the aberration of the tangential image plane (denoted as “T”).

FIG. 4A is a graph illustrating astigmatic aberration and field curvature with respect to the eyeball rotation angle in the case where the aforementioned f1/f2 is −0.225. The left view in FIG. 4A represents the case where the reference diopter is +1D, and the right view represents the case where the reference diopter is −4D. Compared to the case of the reference diopter, the variation in the focal length of the entire optical system in the case where the reference diopter is +1D is valued at −0.46%. Furthermore, the variation in the focal length of the entire optical system in the case where the reference diopter is −4D is valued at 1.87%.

FIG. 4B is a graph illustrating astigmatic aberration and field curvature with respect to the eyeball rotation angle in the case where the aforementioned f1/f2 is −0.526. The left view in FIG. 4B represents the case where the reference diopter is +1D, and the right view represents the case where the reference diopter is −4D. The variation in focal length of the entire optical system in the case where the reference diopter is +1D is valued at −1.08%. Furthermore, the variation in focal length of the entire optical system in the case where the reference diopter is −4D is valued at 4.50%.

FIG. 4C is a graph illustrating astigmatic aberration and field curvature with respect to the eyeball rotation angle in the case where the aforementioned f1/f2 is −0.399. The left view in FIG. 4C represents the case where the reference diopter is +1D, and the right view represents the case where the reference diopter is −4D. The variation in focal length of the entire optical system in the case of reference diopter is +1D is valued at 0.79%. Furthermore, the variation in the focal length of the entire optical system in the case where the reference diopter is −4D is valued at −2.28%.

In the case where f1/f2 is relatively small (FIG. 4A), variations in astigmatic aberration and field curvature with respect to variations in diopter become small. On the other hand, in the case where f1/f2 approaches the upper and lower limits of the above conditional expression (1) (FIGS. 4B and 4C), variations in astigmatic aberration and field curvature with respect to variation in diopter increase. Moreover, in the case where f1/f2 deviates from the range defined by the above conditional expression (1), both astigmatic aberration and field curvature vary greatly during diopter adjustment, leading to considerable variations in the focal length of the entire optical system. This changes the image size in the observation unit 390 significantly. Setting the focal length of the second lens group 200 to a value that satisfies −0.6<f1/f2<0.4 makes it possible to keep the variations in astigmatic aberration, field curvature, and focus of the entire optical system between each diopter within a practical range.

### [Light Ray Bending Angle of Second Lens Group]

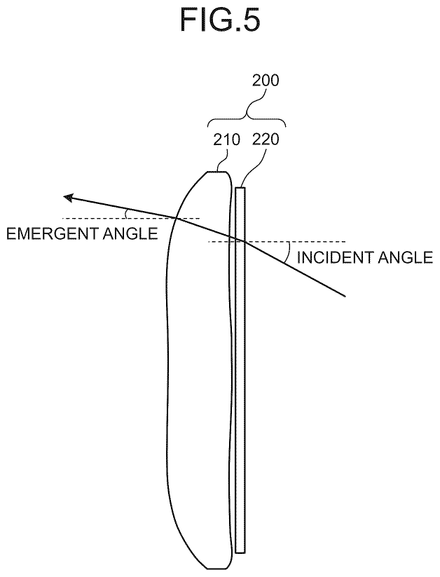

FIG. 5 is a diagram illustrating an example of a light ray bending angle of the second lens group according to the first embodiment of the present disclosure. The depicted figure is a diagram illustrating an example of the incident angle and the emergent angle in the second lens group 200. These incident angles and emergent angles are based on the assumption that the principal ray of the light corresponds to the maximum angle of view of the optical system 10. The second lens group 200 can be configured so that the difference between the incident angle and the emergent angle illustrated in the depicted figure is larger than 5 degrees. Specifically, in the case where the incident angle is AOI2 and the emergent angle is AOI1, the second lens group 200 is configured to have a light ray bending angle such that AOI2−AOI1>5. This ensures the amount of inward bending of the principal light ray at the maximum angle of view, allowing for diopter adjustment while maintaining the image plane integrity.

### [Shape of Lens]

FIGS. 6 and 7 are diagrams illustrating an example of the shape of a lens according to the first embodiment of the present disclosure. FIG. 6 is a diagram illustrating the surface data of lenses of the optical system 10. In the table of FIG. 6, “SURFACE NUMBER” represents the surface corresponding to the number in parentheses illustrated in the right view of FIG. 6. Moreover, “*” represents an aspherical surface. “CURVATURE RADIUS” represents the radius of curvature of a surface. Moreover, in the case where the “SURFACE” is an aspherical surface, it represents the paraxial radius of curvature. “SPACING” represents the distance between surfaces along the optical axis. “REFRACTIVE INDEX” represents the refractive index of the lens material at the d-line (wavelength of 587.6 nm). “ABBE NUMBER” represents the Abbe number with respect to the d-line as the reference. “EFFECTIVE DIAMETER” represents the length of the diameter of the surface. Moreover, regarding the surface spacing (variable) with the surface number “15”, the values for −0.5D and −3.5D are listed in the diopter adjustment data in the attached table.

Moreover, the depicted figure represents an example in which a glass plate 312 is arranged to cover the image display surface 311 of the display element 310.

Further, FIG. 7 is a diagram illustrating aspheric data of the lens of the optical system 10. The “ASPHERIC COEFFICIENT” in the depicted figure represents the coefficient of the mathematical formula in the depicted figure. This formula represents the sag amount Z of the aspherical surface at the position h from the optical axis. Moreover, the tenth and twelfth surfaces in FIG. 6 have the same aspheric coefficient as the fourth surface. Further, the ninth and 13th surfaces have the same aspheric coefficient as the fifth surface. In addition, the 15th surface has the same aspheric coefficient as the seventh surface.

The focal length of the first lens group 100 is 19.04 mm, and the focal length of the second lens group 200 is 658.46 mm. In addition, the focal length of the optical system 10 is 19.30 mm. Moreover, the maximum image height is 12.09 mm.

In the case where spherical lenses are arranged in place of the first aspherical lens 120 and the second aspherical lens 130, astigmatic aberration and field curvature are insufficiently corrected. In contrast, arranging two aspherical lenses (first aspherical lens 120 and second aspherical lens 130) in the triple-pass optical path makes it possible to correct astigmatic aberration and field curvature easily. In addition, it is preferable that the surface of the first aspherical lens 120 on the side facing the image display surface 311 and the surface of the second aspherical lens 130 on the side facing the observation unit 390 are aspherical and are spaced apart from each other.

In the case where the maximum effective radius of the entire optical system 10 is Rmax, the shape of the first aspherical lens 120 at the position (h) of approximately 0.25×Rmax to 0.75×Rmax or approximately −0.25×Rmax to −0.75×Rmax is considered. In this region, the first aspherical lens 120 locally constitutes a concave lens, and the second aspherical lens 130 locally constitutes a convex lens. Further, the first aspherical lens 120 is configured to have a higher absolute focal length than the second aspherical lens. Specifically, the focal length of the first aspherical lens 120 is configured to be −150.89 mm, while the focal length of the second aspherical lens 130 is configured to be 54.63 mm. In addition, as illustrated in FIG. 6, the first aspherical lens is made of a member with a refractive index higher than that of the second aspherical lens 130 at the d-line and a member with an Abbe number lower than that of the second aspherical lens 130 at the d-line. This makes it possible to correct chromatic aberration of magnification effectively. In addition, configuring the refractive power of the first aspherical lens 120 to be negative (focal length of the first aspherical lens 120<0) makes it possible to correct axial chromatic aberration effectively.

### [Resolution of Optical System]

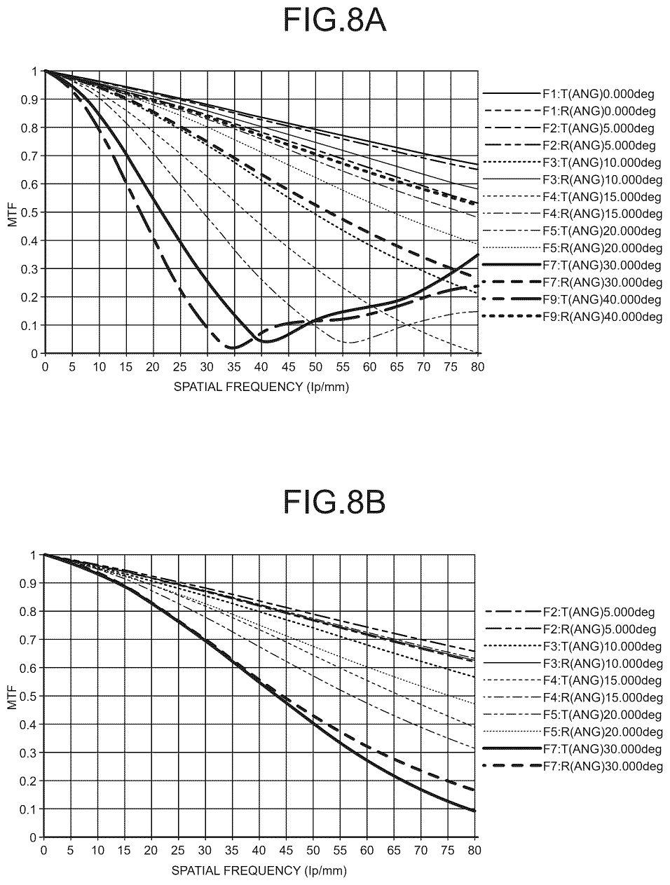

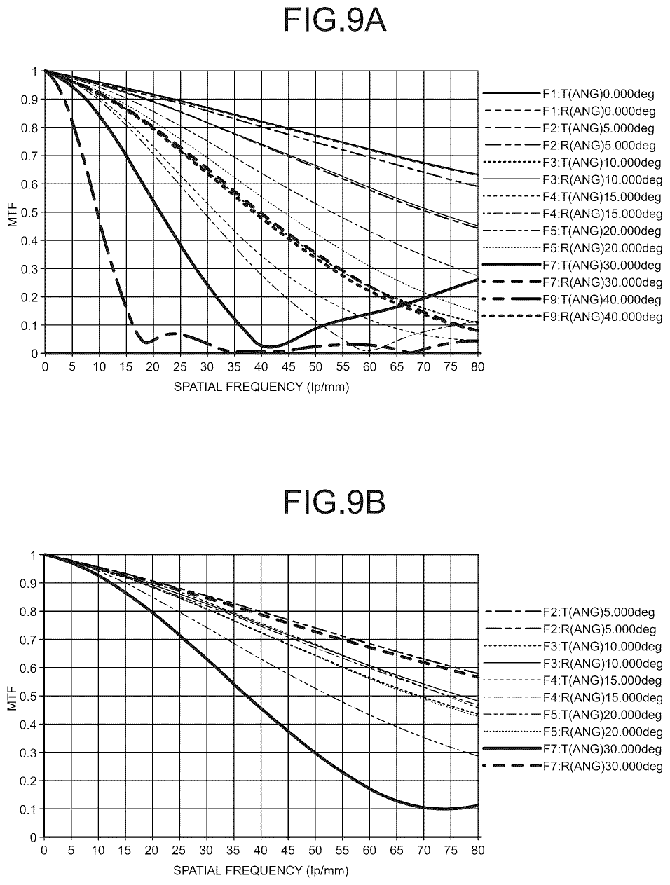

FIGS. 8A, 8B, 9A, and 9B are diagrams illustrating an example of the resolution of the optical system according to the first embodiment of the present disclosure. These figures are diagrams illustrating an example of the resolution of the optical system 10. The horizontal axis in the depicted figure represents the spatial frequency of incident light. The vertical axis represents a modulation transfer function (MTF). The MTF corresponds to the contrast of emitted light. Moreover, the MTF in the depicted figure is calculated by weighted averaging using weights according to wavelengths. The weight has a value of “5.4” at a wavelength of 658.0 nm, a value of “71.9” at a wavelength of 616.0 nm, a value of “100” at a wavelength of 554.0 nm, a value of “50.4” at a wavelength of 510.0 nm, and the value is “5.4” at a wavelength of 456.0 nm.

In these figures, F1 represents the MTF curve at a half-angle of view of 0 degrees, F2 represents an MTF curve at a half-angle of view of 5 degrees, F3 represents an MTF curve at a half-angle of view of 10 degrees, F4 represents an MTF curve at a half-angle of view of 15 degrees, F5 represents an MTF curve at a half-angle of view of 20 degrees, F7 represents an MTF curve at a half-angle of view of 30 degrees, and F9 represents an MTF curve at a half angle of view of 40 degrees. In addition, T represents an MTF curve in the concentric direction, and R represents an MTF curve in the radial direction.

Further, FIGS. 8A and 8B represent the case where the diopter is −0.5D, and FIGS. 9A and 9B represent the case where the diopter is −3.5D. In addition, FIGS. 8A and 9A represent the MTF in the case where the eyeball is not rotated, and FIGS. 8B and 9B represent the MTF with respect to the eyeball rotation angle in the case where the eyeball is rotated. The eyeball rotation angle will be described later. As illustrated in these figures, the full angle of view of the optical system 10 can be set to 80 degrees (half angle of view of 40 degrees).

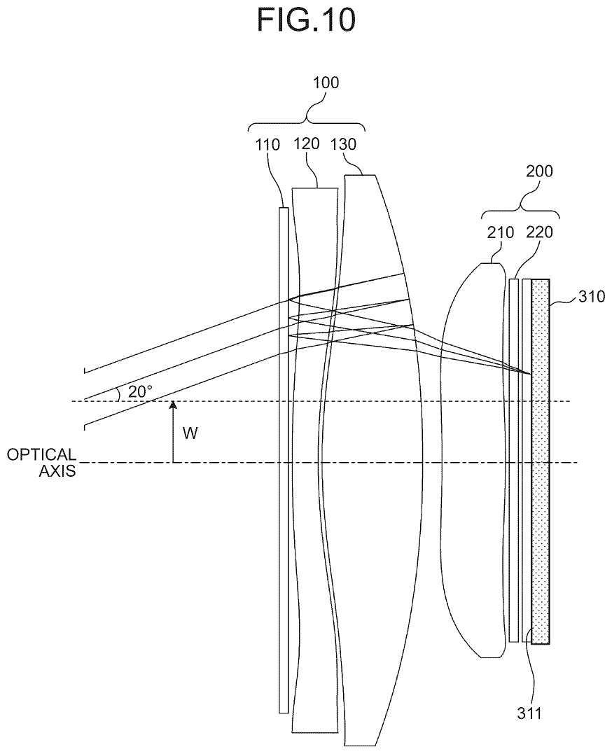

FIG. 10 is a diagram illustrating an example of eyeball rotation according to the embodiment of the present disclosure. The depicted figure is a diagram illustrating the MTF during the eyeball rotation described above. This eyeball rotation MTF refers to the MTF regarding the image plane of the fixation point in a state where the eyeball is making a rotational motion. The eyeball rotation MTF can be obtained by shifting the pupil position in the Y-axis direction by a value of “13×tan θ” [unit: mm] and dividing the pupil diameter by cos θ in the case where the eyeball rotation angle is θ, and by calculating the MTF at the angle of view θ. Here, 13 mm corresponds to the approximate radius of the human eyeball. This figure illustrates an example in which the eyeball rotation angle is 20 degrees. The pupil position is shifted by W corresponding to 13×tan 20 degrees with respect to the optical axis, and the MTF for an angle of view of 20 degrees is calculated.

In this way, the optical system 10 according to the first embodiment of the present disclosure is capable of easily adjusting aberrations by combining the first aspherical lens 120 and the second aspherical lens 130 with positive refractive power.

### 2. Second Embodiment

The optical system 10 according to the first embodiment described above is configured to have the angle of view of 80 degrees. On the other hand, an example will be described in which an optical system 10 according to a second embodiment of the present disclosure is configured to have an angle of view of 100 degrees.

### [Configuration of Display Device]

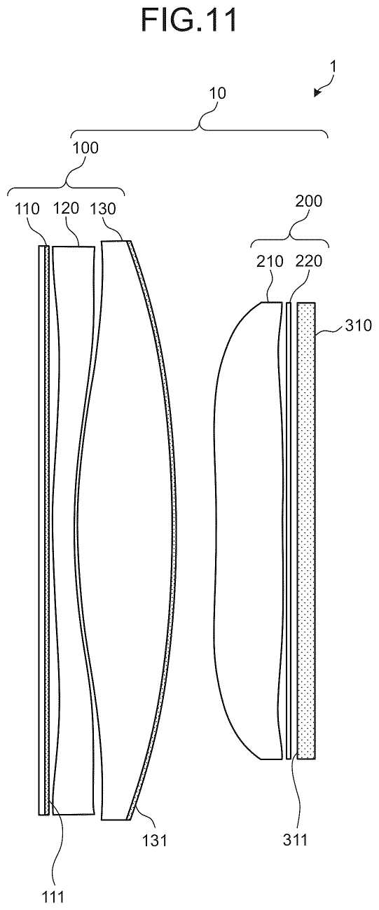

FIG. 11 is a diagram illustrating an exemplary configuration of a display device according to the second embodiment of the present disclosure. This figure is a cross-sectional view illustrating an exemplary configuration of the display device 1, similar to FIG. 1. The optical system 10 in the depicted figure differs from that in FIG. 1 in the shape of the lens.

### [Configuration of First Aspherical Lens]

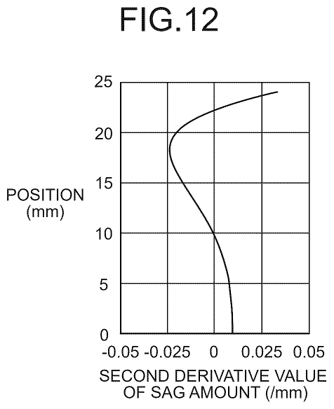

FIG. 12 is a diagram illustrating an exemplary configuration of a first aspherical lens according to the second embodiment of the present disclosure. This figure, similar to the right view of FIG. 2A, is a graph illustrating the relationship between the position (h) of the first aspherical lens 120 and the second derivative value of the sag amount. Also in the depicted figure, there are two points where the second derivative value of the sag amount is “0”, and the value at the central portion is positive.

### [Shape of Lens]

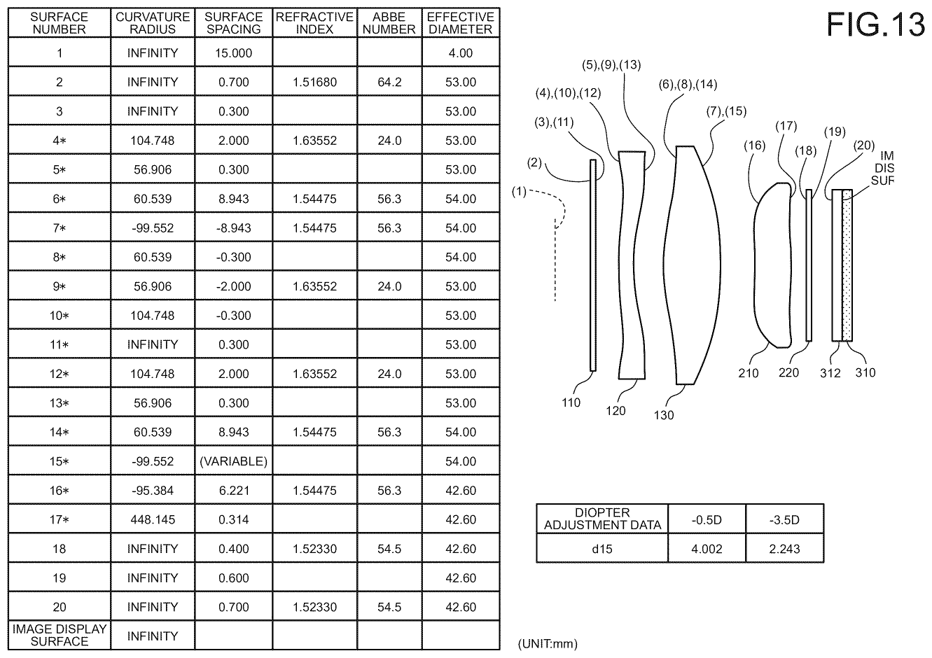

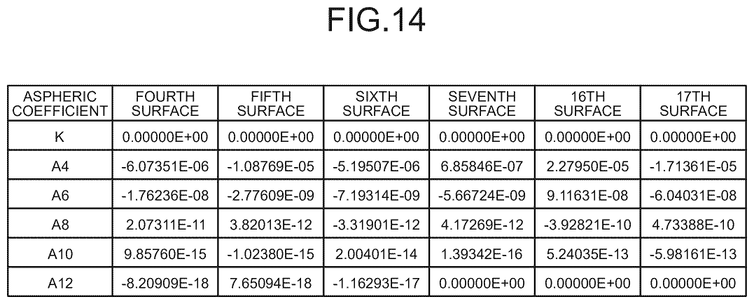

FIGS. 13 and 14 are diagrams illustrating an example of the shape of a lens according to the second embodiment of the present disclosure. Similar to FIG. 6, FIG. 13 is a diagram illustrating surface data of the lens of the optical system 10. Further, similar to FIG. 7, FIG. 14 is a diagram illustrating aspheric data of the lens of the optical system 10. The markings in FIGS. 13 and 14 are the same as in FIGS. 6 and 7, respectively.

The focal length of the first lens group 100 is 23.85 mm, and the focal length of the second lens group 200 is −143.31 mm. In addition, the focal length of the optical system 10 is 24.73 mm. Moreover, the maximum image height is 18.00 mm.

### [Resolution of Optical System]

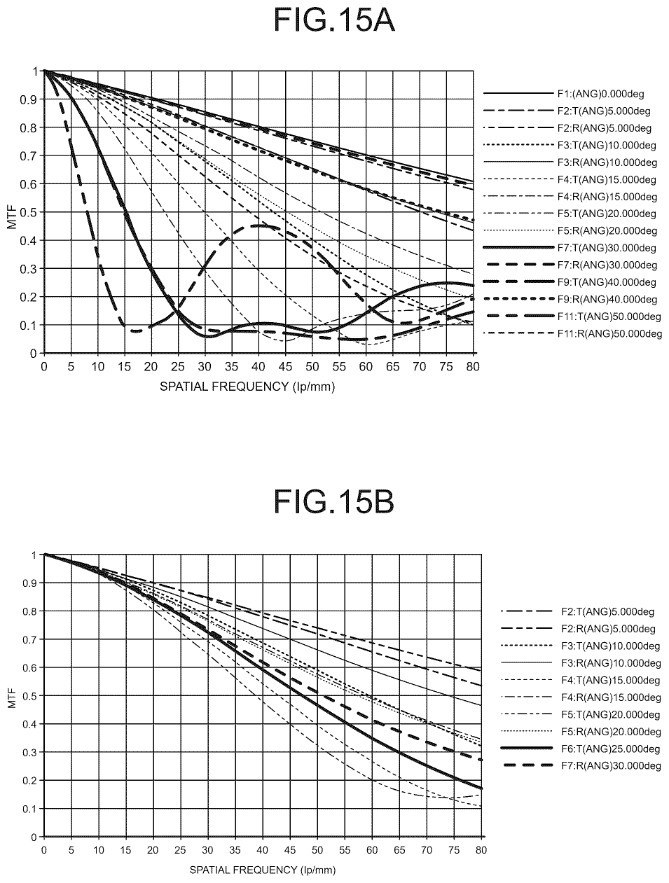

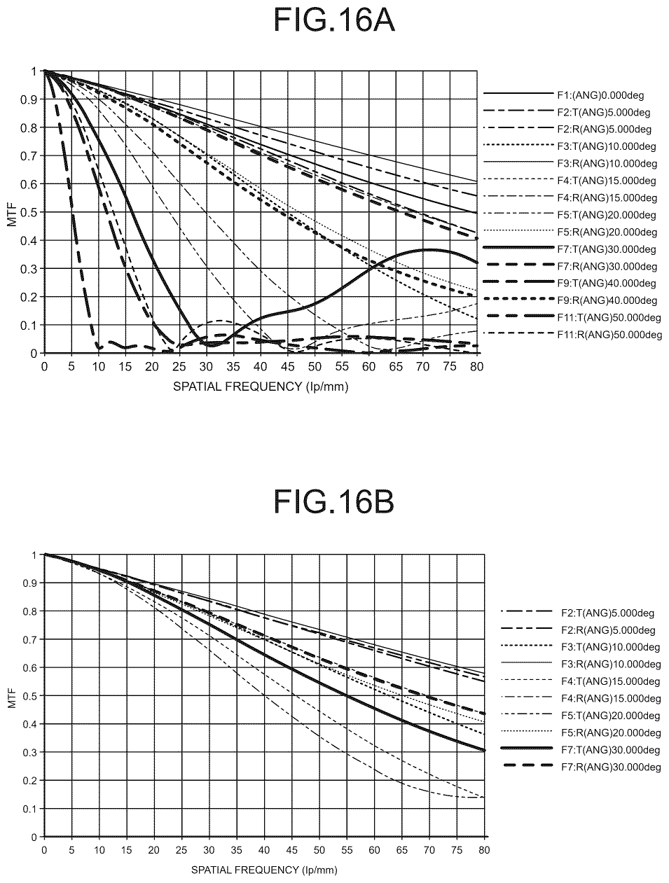

FIGS. 15A, 15B, 16A, and 16B are diagrams illustrating an example of the resolution of the optical system according to the second embodiment of the present disclosure. These figures, similar to FIG. 8, are diagrams illustrating an example of the resolution of the optical system 10. In these figures, F10 represents an MTF curve with a half angle of view of 50 degrees. Otherwise, the same markings as in FIG. 8A are used. In addition, FIGS. 15A and 15B illustrate the case of a diopter of −0.5D, and FIGS. 16A and 16B illustrate the case of a diopter of −3.5D. Furthermore, FIGS. 15A and 16A represent the MTF in the case where the eyeball is not rotated, and FIGS. 15B and 16B represent the MTF with respect to the eyeball rotation angle in the case where the eyeball is rotated. As illustrated in these figures, the total angle of view of the optical system 10 can be set to 100 degrees (half angle of view of 50 degrees).

The configuration of the display device 1 other than that described is similar to the configuration of the display device 1 according to the first embodiment of the present disclosure, so the repetitive description will be omitted.

In this way, the optical system 10 according to the second embodiment of the present disclosure can have an angle of view of 100 degrees.

### 3. Third Embodiment

The optical system 10 according to the first embodiment described above includes two aspherical lenses, i.e., the first aspherical lens 120 and the second aspherical lens 130 in the first lens group 100. On the other hand, an optical system 10 according to a third embodiment of the present disclosure differs from the above-described first embodiment in that it includes three aspherical lenses.

### [Configuration of Display Device]

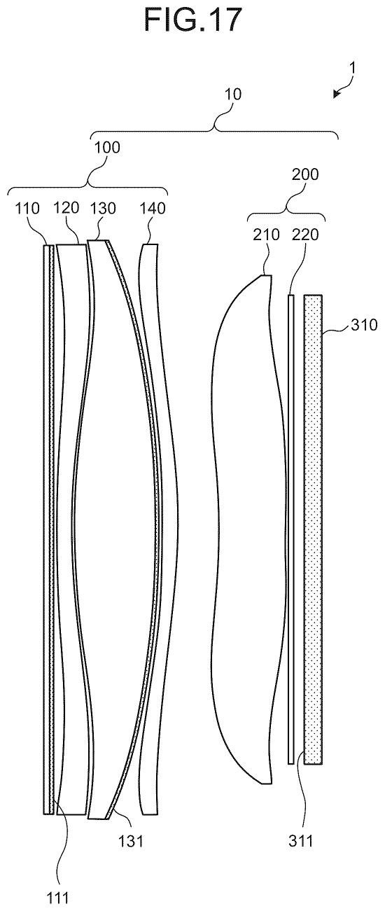

FIG. 17 is a diagram illustrating an exemplary configuration of a display device according to the third embodiment of the present disclosure. This figure, similar to FIG. 1, is a cross-sectional view illustrating an exemplary configuration of the display device 1. The optical system 10 in the depicted figure differs from the optical system 10 in FIG. 1 in that a third aspherical lens 140 is arranged in the first lens group 100.

The third aspherical lens 140 is an aspherical lens arranged on the side of the second aspherical lens 130 facing the image display surface 311.

### [Configuration of First Aspherical Lens]

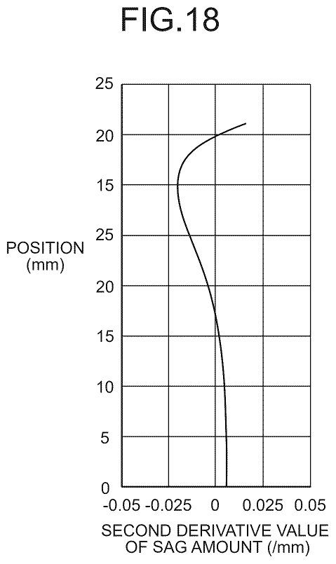

FIG. 18 is a diagram illustrating an exemplary configuration of the first aspherical lens according to the third embodiment of the present disclosure. This figure, similar to the left view of FIG. 2A, is a graph illustrating the relationship between the position (h) of the first aspherical lens 120 and the second derivative value of the sag amount. Also in the depicted figure, there are two points where the second derivative value of the sag amount is “0”, and the value at the central portion is positive.

### [Shape of Lens]

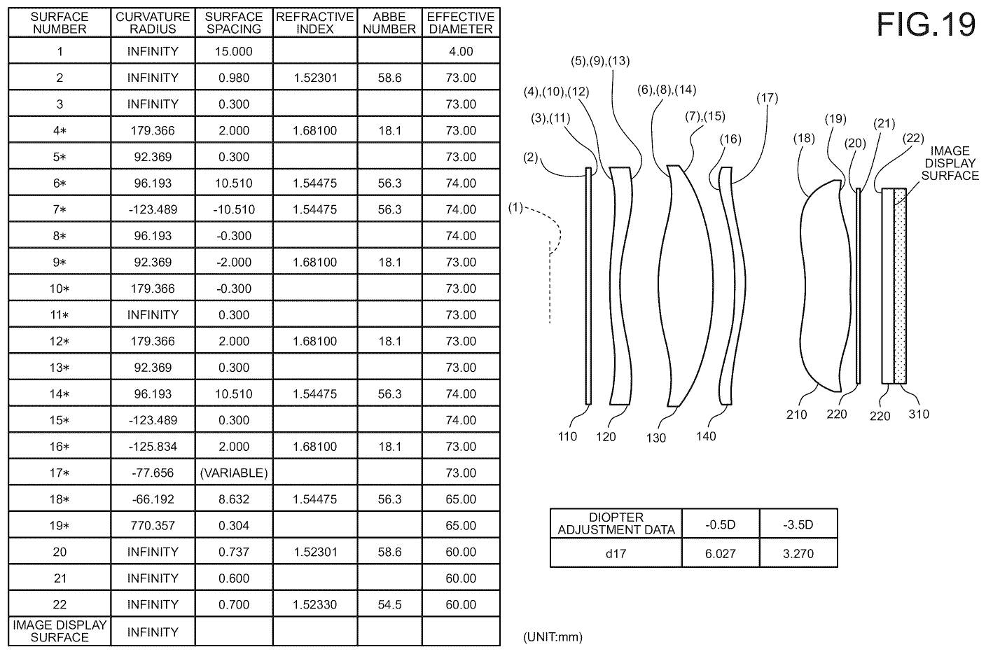

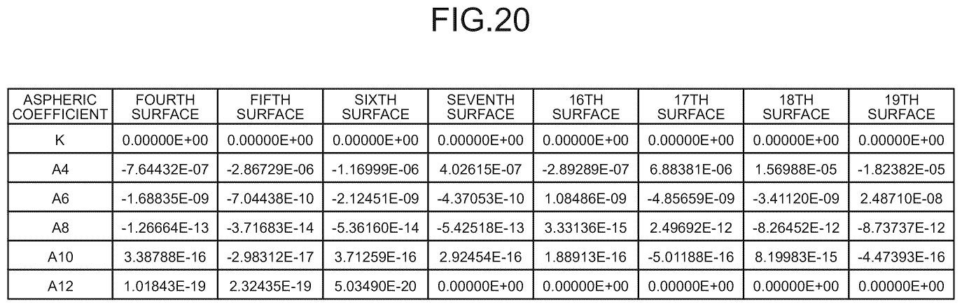

FIGS. 19 and 20 are diagrams illustrating an example of the shape of a lens according to the third embodiment of the present disclosure. Similar to FIG. 6, FIG. 19 is a diagram illustrating surface data of the lens of the optical system 10. In addition, similar to FIG. 7, FIG. 20 is a diagram illustrating aspheric data of the lens of the optical system 10. The markings in FIGS. 19 and 20 are the same as in FIGS. 6 and 7, respectively.

The focal length of the first lens group 100 is 30.00 mm, and the focal length of the second lens group 200 is −111.12 mm. In addition, the focal length of the optical system 10 is 32.01 mm. Moreover, the maximum image height is 27.00 mm.

### [Resolution of Optical System]

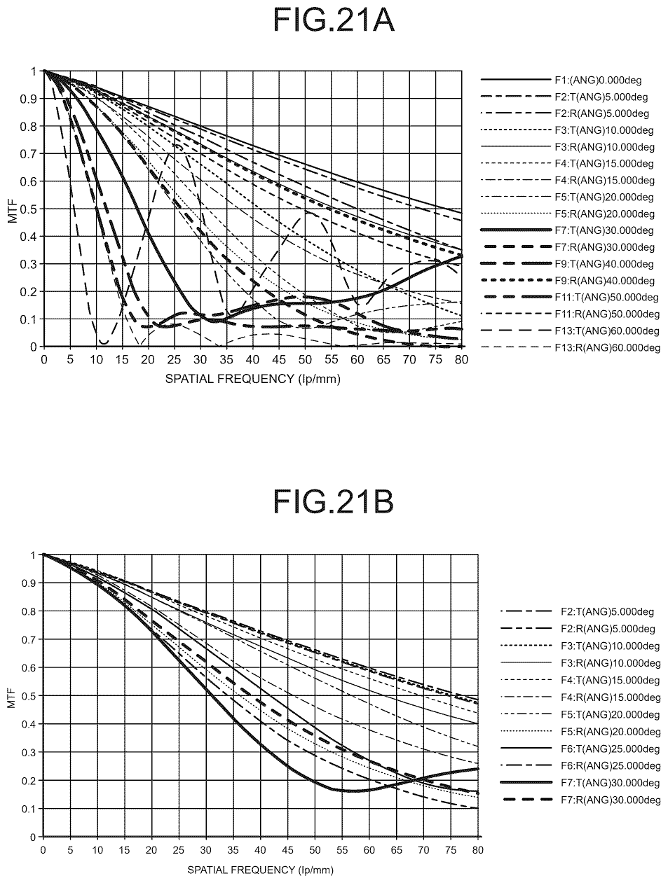

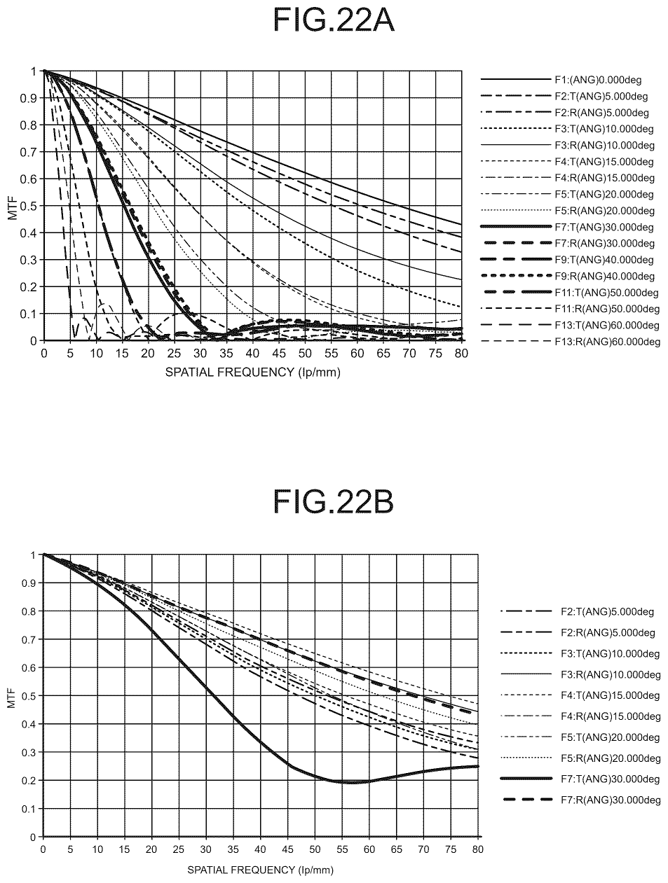

FIGS. 21A, 21B, 22A, and 22B are diagrams illustrating an example of the resolution of the optical system according to the third embodiment of the present disclosure. These figures, similar to FIG. 8, are diagrams illustrating an example of the resolution of the optical system 10. In these figures, F11 represents an MTF curve with a half angle of view of 50 degrees, and F13 represents an MTF curve with a half angle of view of 60 degrees. Otherwise, the same markings as in FIG. 8A are used. In addition, FIGS. 21A and 21B illustrate the case of a diopter of −0.5D, and FIGS. 22A and 22B illustrate the case of a diopter of −3.5D. Moreover, FIGS. 21A and 22A represent the MTF in the case where the eyeball is not rotated, and FIGS. 21B and 22B represent the MTF with respect to the eyeball rotation angle in the case where the eyeball is rotated. As illustrated in these figures, the total angle of view of the optical system 10 can be set to 120 degrees (half angle of view of 60 degrees).

Moreover, in the optical system 10 of FIG. 17, a meniscus lens can also be arranged between the transparent flat plate 110 and the observation unit 390. This arrangement allows the total angle of view to be further expanded.

The configuration of the display device 1 other than that described is similar to the configuration of the display device 1 according to the first embodiment of the present disclosure, so the repetitive description will be omitted.

In this way, the optical system 10 according to the third embodiment of the present disclosure can have an angle of view of 120 degrees by adding the third aspherical lens 140 to the first lens group 100.

### 4. Fourth Embodiment

The optical system 10 according to the first embodiment described above includes the aspherical lens 210 and the transparent flat plate 220 in the second lens group 200. On the other hand, an optical system 10 according to a fourth embodiment of the present disclosure differs from the above-described first embodiment in that it includes a second lens group 200 including a plurality of aspherical lenses.

### [Configuration of Display Device]

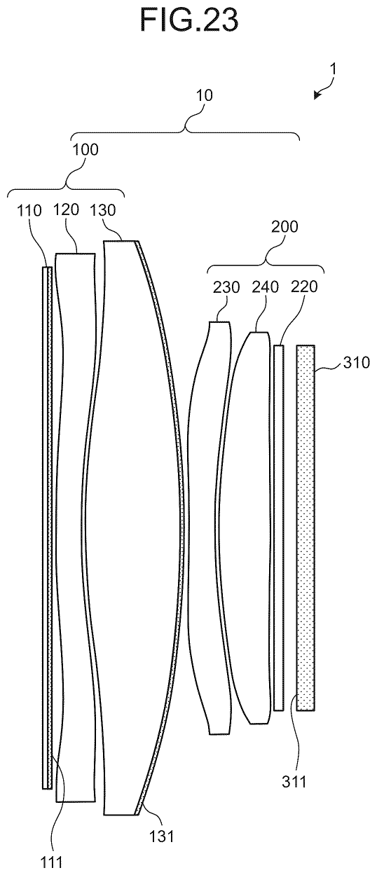

FIG. 23 is a diagram illustrating an exemplary configuration of a display device according to the fourth embodiment of the present disclosure. This figure, similar to FIG. 1, is a cross-sectional view illustrating an exemplary configuration of the display device 1. The optical system 10 in the depicted figure differs from the optical system 10 in FIG. 1 in that aspherical lenses 230 and 240 are arranged, instead of the aspherical lens 210, in the second lens group 200.

The aspherical lenses 240 and 230 are arranged adjacent to the transparent flat plate 220 in this order.

### [Configuration of First Aspherical Lens]

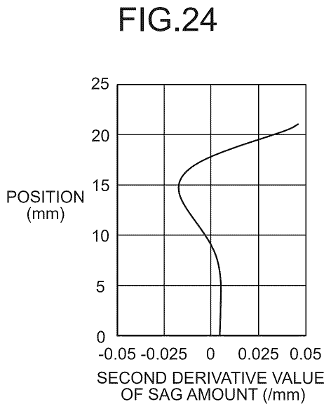

FIG. 24 is a diagram illustrating an exemplary configuration of the first aspherical lens according to the fourth embodiment of the present disclosure. This figure, similar to the left view of FIG. 2A, is a graph illustrating the relationship between the position (h) of the first aspherical lens 120 and the second derivative value of the sag amount. Also in the depicted figure, there are two points where the second derivative value of the sag amount is “0”, and the value at the central portion is positive.

### [Shape of Lens]

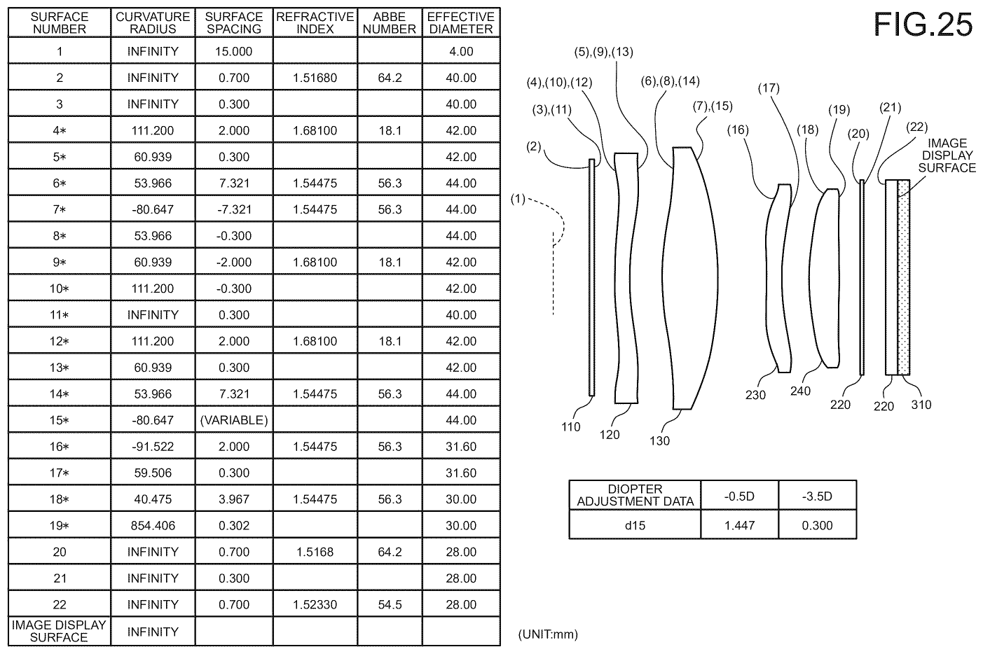

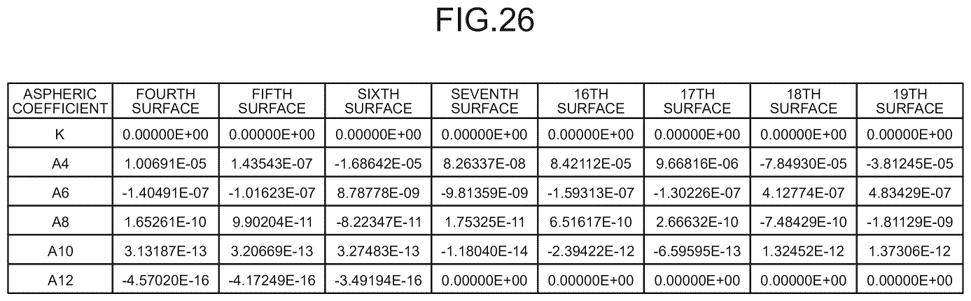

FIGS. 25 and 26 are diagrams illustrating an example of the shape of a lens according to the fourth embodiment of the present disclosure. Similar to FIG. 6, FIG. 25 is a diagram illustrating surface data of the lens of the optical system 10. In addition, similar to FIG. 7, FIG. 26 is a diagram illustrating aspheric data of the lens of the optical system 10. The markings in FIGS. 25 and 26 are the same as in FIGS. 6 and 7, respectively.

The focal length of the first lens group 100 is 19.31 mm, and the focal length of the second lens group 200 is −452.85 mm. Further, the focal length of the optical system 10 is 19.70 mm. Moreover, the maximum image height is 12.09 mm.

### [Resolution of Optical System]

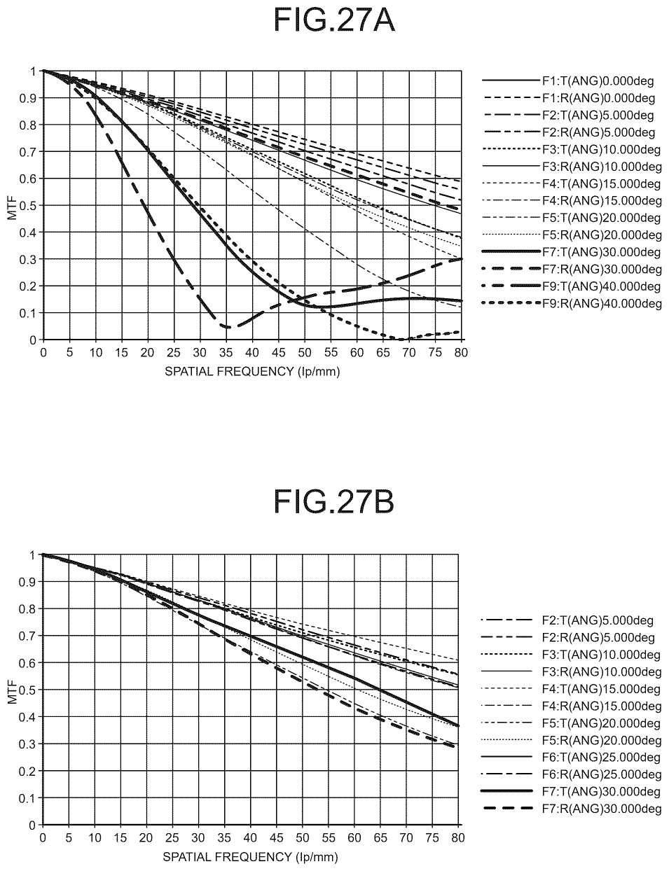

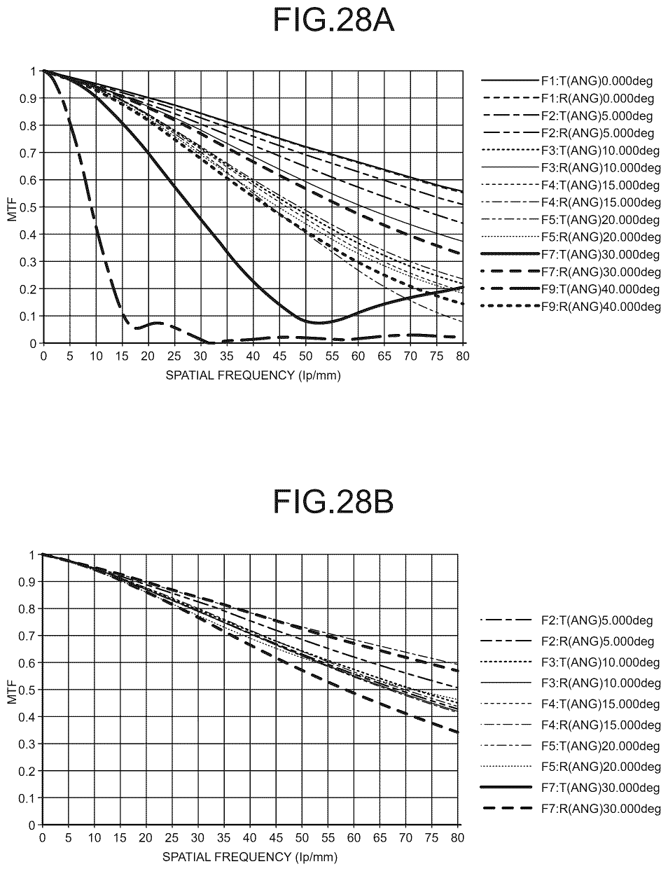

FIGS. 27A, 27B, 28A, and 28B are diagrams illustrating an example of the resolution of the optical system according to the fourth embodiment of the present disclosure. These figures, similar to FIG. 8, are diagrams illustrating an example of the resolution of the optical system 10. These figures use the same markings as FIG. 8A. Further, FIGS. 27A and 27B illustrate the case of a diopter of −0.5D, and FIGS. 28A and 28B illustrate the case of a diopter of −3.5D. In addition, FIGS. 27A and 28A represent the MTF in the case where the eyeball is not rotated, and FIGS. 27B and 28B represent the MTF with respect to the eyeball rotation angle in the case where the eyeball is rotated. As illustrated in these figures, the total angle of view of the optical system 10 can be set to 80 degrees (half angle of view of 40 degrees).

The configuration of the display device 1 other than that described is similar to the configuration of the display device 1 according to the first embodiment of the present disclosure, so the repetitive description will be omitted.

As described above, the optical system 10 according to the fourth embodiment of the present disclosure can have an angle of view of 80 degrees in the configuration in which a plurality of aspherical lenses is arranged in the second lens group 200.

### 5. Fifth Embodiment

The optical system 10 of the first embodiment described above guides the incident light as it is. On the other hand, an optical system 10 according to a fifth embodiment of the present disclosure differs from the above-described first embodiment in that the optical system 10 adjusts the polarization direction of incident light and guides the incident light.

### [Configuration of Display Device]

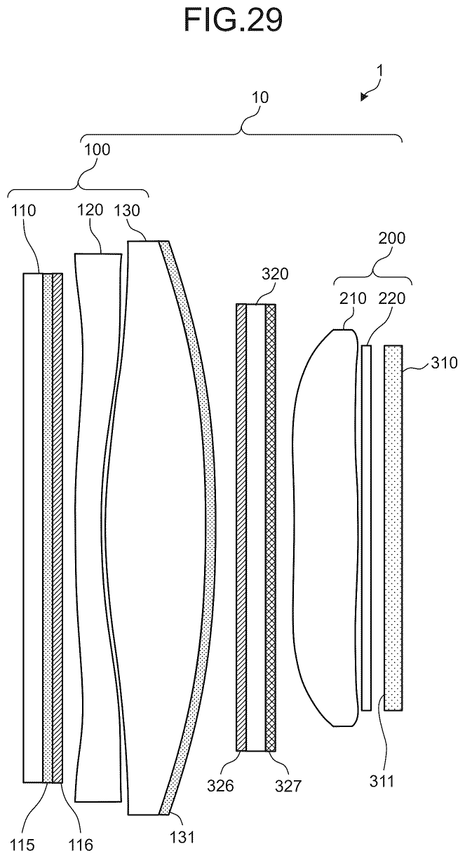

FIG. 29 is a diagram illustrating an exemplary configuration of a display device according to the fifth embodiment of the present disclosure. This figure, similar to FIG. 1, is a cross-sectional view illustrating an exemplary configuration of the display device 1. The optical system 10 in the depicted figure differs from the optical system 10 in FIG. 1 in that it further includes a transparent flat plate 320.

In the optical system 10 illustrated in the depicted figure, the transparent flat plate 320 is arranged between the first lens group 100 and the second lens group 200. The transparent flat plate 320 has a polarization unit 327 arranged on the side of the transparent flat plate 320 facing the image display surface 311. The polarization unit 327 is used to transmit linearly polarized incident light in a specific direction among the incident light from the display element 310. For example, an absorption-type polarizing plate can be used for the polarization unit 327. Further, a polarization state-changing unit 326 is arranged on the side of the transparent flat plate 320 facing the observation unit 390. The polarization state-changing unit 326 is used to change the polarization state of incident light between linearly polarized light and circularly polarized light. For example, a quarter wavelength plate can be used for the polarization state-changing unit 326.

Further, on the transparent flat plate 110 illustrated in the depicted figure, a polarization selection element 115 is arranged in place of the first transflective surface 111. This polarization selection element 115 is used to reflect one portion of incident light and transmit another portion of incident light, with their polarization directions differing by 90 degrees from each other. For example, a reflective polarizing plate can be used for the polarization selection element 115.

Moreover, the shape of the lens of the optical system 10 according to the present embodiment is similar to that of the optical system 10 according to the first embodiment, so the repetitive description will be omitted. Moreover, a polarization state-changing unit 116 is an example of a second polarization state-changing unit described in the claims. The polarization state-changing unit 326 is an example of a first polarization state-changing unit described in the claims. The transparent flat plate 320 is an example of a third transparent element described in the claims.

### [Optical Path of Optical System]

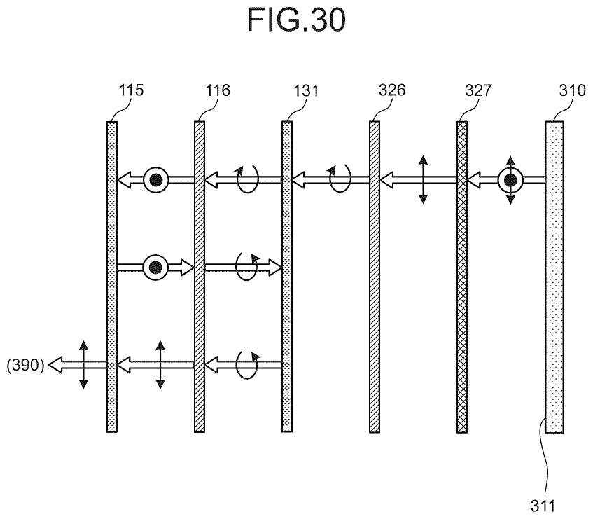

FIG. 30 is a diagram illustrating an example of the optical path of the optical system according to the fifth embodiment of the present disclosure. This figure is a diagram illustrating the state of polarization of incident light on the optical path from the display element 310 to the observation unit 390. In the depicted figure, illustrations of the transparent flat plates 110, 220, and 320, the first aspherical lens 120, the second aspherical lens 130, the aspherical lens 210, and the first aspherical lens 120 are omitted. The white arrows in the depicted figure represent the optical paths of incident light.

The light emitted from the display element 310 enters the polarization unit 327 in an unpolarized state. This incident light is converted into linearly polarized light by the polarization unit 327. Then, the incident light enters the polarization state-changing unit 326. The polarization state-changing unit 326 allows the incident light to be converted into circularly polarized light. This incident light passes through the second transflective surface 131 and enters the polarization state-changing unit 116. The incident light is converted into linearly polarized light by the polarization state-changing unit 116 and enters the polarization selection element 115. The incident light is reflected by the polarization selection element 115 and is converted into circularly polarized light by the polarization state-changing unit 116. In this case, the light is converted into circularly polarized light in a direction different from that in the previous transmission. This incident light is reflected by the second transflective surface 131 and enters the polarization state-changing unit 116 again. This converted incident light is converted into linearly polarized light by the polarization state-changing unit 116. In this case, the light is converted into linearly polarized light in a direction 90 degrees different from that in the previous transmission. The incident light in this polarization direction passes through the polarization selection element 115 and reaches the observation unit 390.

In this way, arranging the polarization selection element 115 and adjusting the polarization direction of the incident light during the first-time and second-time light incidences make it possible to reduce the decrease in the amount of reflected light and transmitted light from the polarization selection element 115 compared to the first transflective surface 111.

Moreover, arranging the transparent flat plate 320 closer to the observation unit 390 than the second lens group 200 makes it possible to reduce polarization disturbance due to birefringence compared to the case where the transparent flat plate 320 is arranged closer to the image display surface 311.

### 6. Sixth Embodiment

The optical system 10 according to the first embodiment described above has the transparent flat plate 110 arranged in the first lens group 100. On the other hand, an optical system 10 according to the sixth embodiment of the present disclosure differs from the above-described first embodiment in that an element having a curved surface is arranged instead of the transparent flat plate 110.

### [Configuration of Display Device]

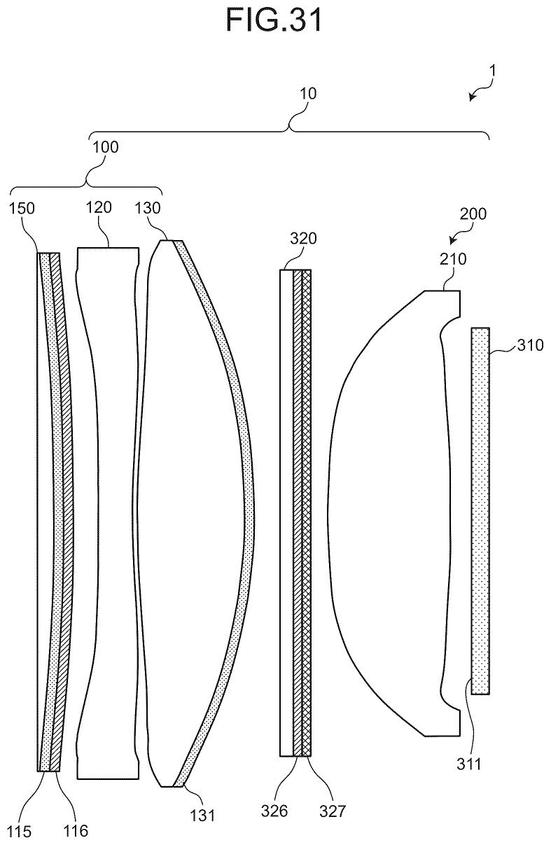

FIG. 31 is a diagram illustrating an exemplary configuration of a display device according to the sixth embodiment of the present disclosure. This figure, similar to FIG. 1, is a cross-sectional view illustrating an exemplary configuration of the display device 1. The optical system 10 in the depicted figure differs from the optical system 10 in FIG. 1 in that it includes a transparent element 150 instead of the transparent flat plate 110. In addition, the optical system 10 in the depicted figure represents an example in which a transparent flat plate 320 is arranged between the first lens group 100 and the second lens group 200, similar to the optical system 10 in FIG. 29.

As described above, the optical system 10 in the depicted figure includes the transparent element 150 instead of the transparent flat plate 110 of the first lens group 100. This transparent element 150, similar to the transparent flat plate 110, is used to transmit the light from the display element 310. In the transparent element 150 illustrated in the depicted figure, the surface on the side of the transparent element 150 facing the observation unit 390 is configured as a flat surface, and the surface on the side of the transparent element 150 facing the display element 310 is configured as a curved surface. On the surface on the side of the transparent element 150 facing the display element 310 in the depicted figure, the polarization selection element 115 and the polarization state-changing unit 116 described with reference to FIG. 29 are stacked.

The first aspherical lens 120 illustrated in the depicted figure is configured to have a shape in which there is at least one position where the second derivative value of the sag amount of the first surface with respect to the position in the radial direction is “0”. In addition, the shape of the second aspherical lens 130 is also different from that of the second aspherical lens 130 illustrated in FIG. 1.

The second lens group 200 illustrated in the depicted figure includes an aspherical lens 210. This aspherical lens 210 also has a different shape from the aspherical lens 210 illustrated in FIG. 1. Moreover, the transparent flat plate 220 arranged in the second lens group 200 illustrated in FIG. 1 can be omitted.

On the transparent flat plate 320 illustrated in the depicted figure, a polarization state-changing unit 326 and a polarization unit 327 are sequentially stacked on the side facing the image display surface 311. As described above, the optical system 10 illustrated in the depicted figure represents an example of the case where the polarization selection element 115 is arranged to adjust the polarization direction of the incident light at the first-time and second-time light incidences, similar to the optical system 10 illustrated in FIG. 29.

### [Configuration of First Aspherical Lens]

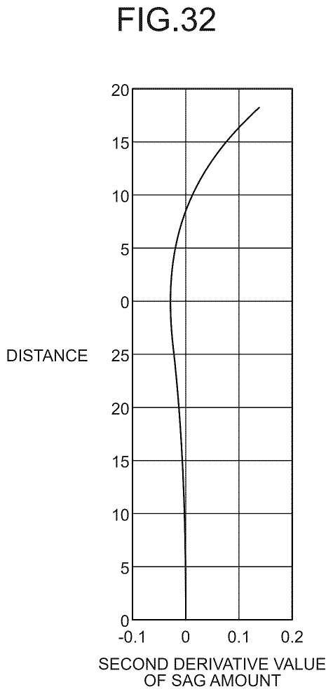

FIG. 32 is a diagram illustrating an exemplary configuration of the first aspherical lens according to the sixth embodiment of the present disclosure. This figure, similar to the right view of FIG. 2A, is a graph illustrating the relationship between the position (h) of the first aspherical lens 120 and the second derivative value of the sag amount. In the depicted figure, the second derivative value of the sag amount at the central portion has a negative value. In this way, in the first aspherical lens 120 according to the sixth embodiment of the present disclosure, there is one point where the second derivative value of the sag amount becomes “0”.

### [Shape of Lens]

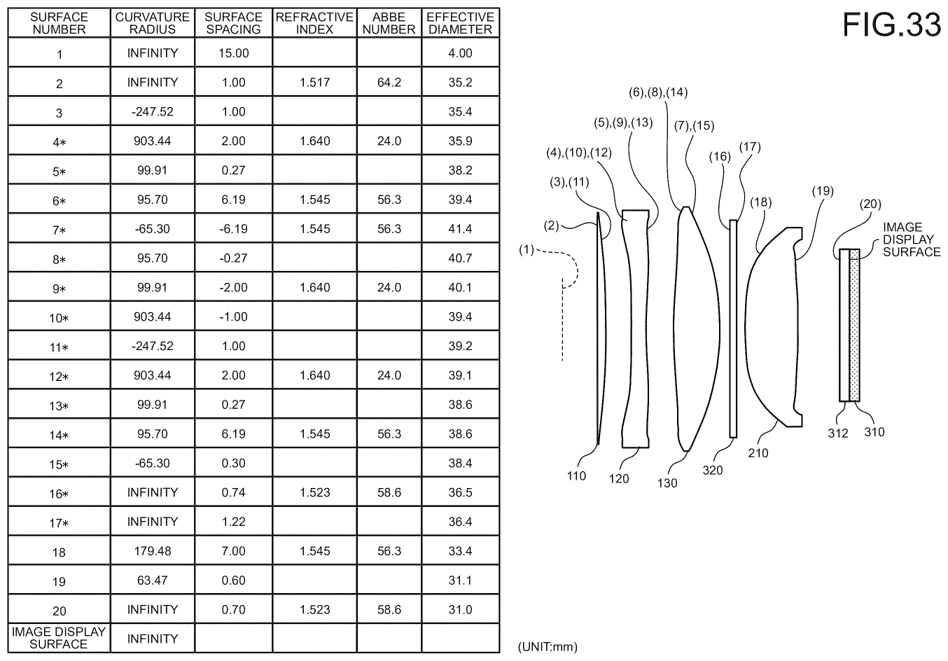

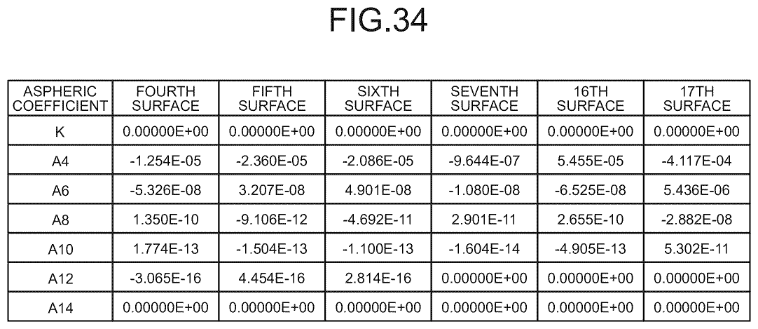

FIGS. 33 and 34 are diagrams illustrating an example of the shape of a lens according to the sixth embodiment of the present disclosure. FIG. 33 is, similar to FIG. 6, a diagram illustrating surface data of the lens of the optical system 10. In addition, similar to FIG. 7, FIG. 34 is a diagram illustrating aspheric data of the lens of the optical system 10. The markings in FIGS. 33 and 34 are the same as in FIGS. 6 and 7, respectively.

The focal lengths of the first aspherical lens 120 and the second aspherical lens 130 are −175.6 mm and 72.0 mm, respectively. The focal length of the first lens group 100 is 93.8 mm. The focal length of the aspherical lens 210 of the second lens group 200 is −183 mm. This results in f1/f2=0.51.

The focal length, maximum image height, and total angle of view of the optical system 10 are 21.2 mm, 15.5 mm, and 90 degrees, respectively. Moreover, the optical system 10 according to the sixth embodiment of the present disclosure does not assume diopter adjustment.

### [Resolution of Optical System]

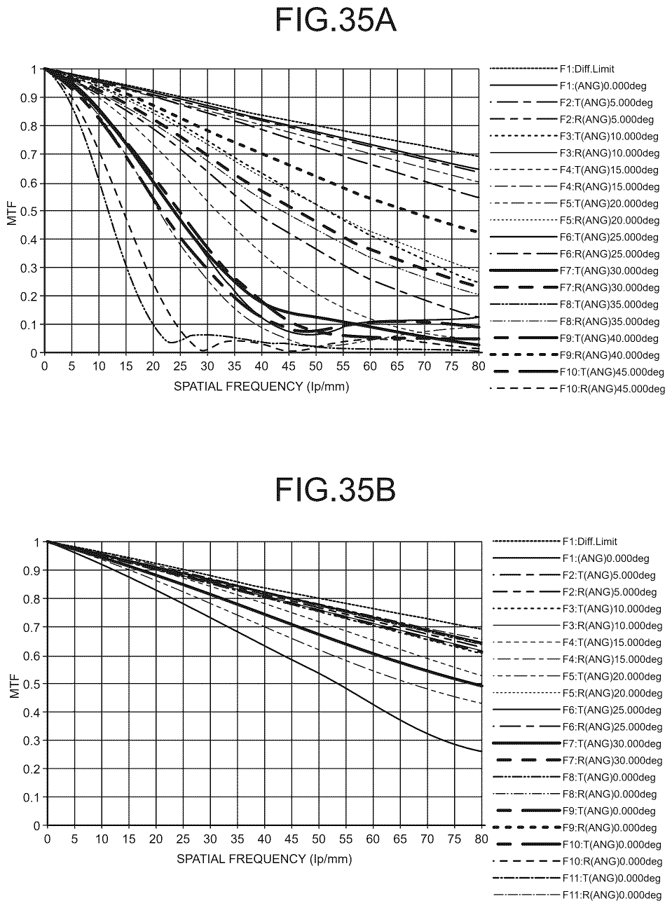

FIGS. 35A and 35B are diagrams illustrating an example of the resolution of the optical system according to the sixth embodiment of the present disclosure. FIG. 35A illustrates the MTF in the case where the eyeball is not rotated, and FIG. 35B illustrates the MTF in the case where the eyeball is rotated. As illustrated in the depicted figure, the MTF in the case where the eyeballs are rotated can be improved.

Moreover, the polarization state-changing unit 326 illustrated in FIG. 31 can also be arranged on the side of the transparent flat plate 320 facing the observation unit 390, similar to FIG. 29. In addition, in FIG. 31, the first transflective surface 111 is arranged in place of the polarization selection element 115 and the polarization state-changing unit 116 of the transparent element 150, and it is also possible to employ a configuration in which the polarization state-changing unit 326 and the polarization unit 327 of the transparent flat plate 320 are omitted.

The configuration of the display device 1 other than that described is similar to the configuration of the display device 1 according to the first embodiment of the present disclosure, so the repetitive description will be omitted.

In this way, the optical system 10 according to the sixth embodiment of the present disclosure uses the transparent element 150 having the curved surface. By arranging the polarization selection element 115 and the polarization state-changing unit 116 on the curved surface of the transparent element 150, the polarization direction of the incident light is adjustable during the first-time and second-time light incidences. This makes it possible to reduce the decrease in the amount of reflected light and transmitted light from the polarization selection element 115 compared to the case where the first transflective surface 111 is used.

### 7. Seventh Embodiment

The optical system 10 according to the first embodiment described above includes the first aspherical lens 120 having the higher refractive index than the second aspherical lens 130. In contrast, an optical system 10 according to a seventh embodiment of the present disclosure differs from the first embodiment in that the refractive index of the second aspherical lens 130 is made higher than the first aspherical lens 120.

### [Configuration of Display Device]

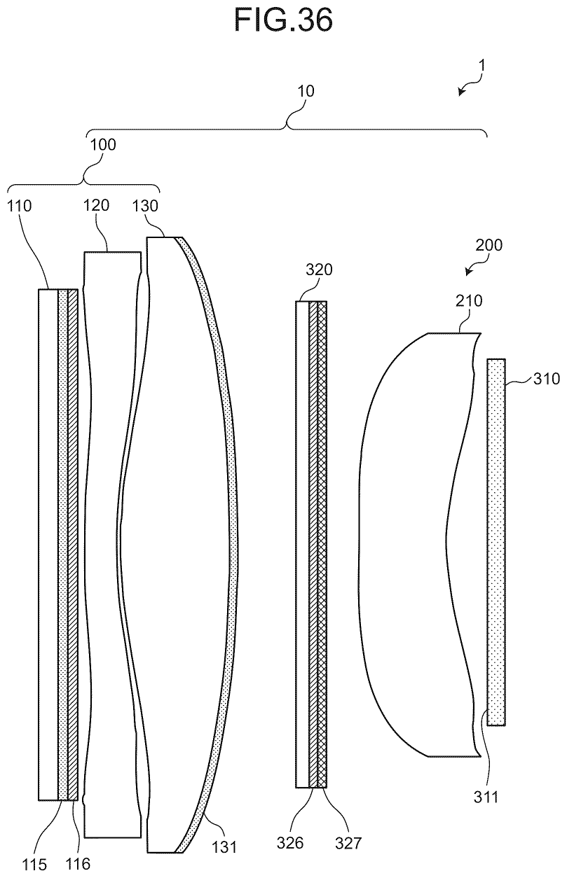

FIG. 36 is a diagram illustrating an exemplary configuration of a display device according to the seventh embodiment of the present disclosure. This figure, similar to FIG. 1, is a cross-sectional view illustrating an exemplary configuration of the display device 1. The optical system 10 in the depicted figure differs from that in FIG. 1 in the shape of the lens or the like. Moreover, the optical system 10 in the depicted figure, similar to the optical system 10 in FIG. 31, represents an example in which the transparent flat plate 320 including the polarization state-changing unit 326 and the polarization unit 327 is arranged between the first lens group 100 and the second lens group 200, and the transparent flat plate 220 of the second lens group 200 is omitted. The polarization selection element 115 and the polarization state-changing unit 116 are stacked on the transparent flat plate 110 in the depicted figure.

As described above, the second aspherical lens 130 in the depicted figure can be configured to have a higher refractive index than the first aspherical lens 120. Further, the second aspherical lens 130 in the depicted figure can be configured to have a higher Abbe number than the first aspherical lens 120. Moreover, a resin lens or a glass molded lens can be applied to the first aspherical lens 120 and the second aspherical lens 130 in the depicted figure.

The second lens group 200 illustrated in the depicted figure includes an aspherical lens 210. This aspherical lens 210 also has a different shape from the aspherical lens 210 illustrated in FIG. 1. Moreover, the transparent flat plate 220 arranged in the second lens group 200 illustrated in FIG. 1 can be omitted.

On the transparent flat plate 320 in the depicted figure, the polarization state-changing unit 326 and the polarization unit 327 are stacked in this order on the side of the transparent flat plate 320 facing the image display surface 311. As described above, the optical system 10 illustrated in the depicted figure represents an example of the case where the polarization selection element 115 is arranged to adjust the polarization direction of the incident light at the first-time and second-time light incidences, similar to the optical system 10 illustrated in FIG. 29.

### [Configuration of First Aspherical Lens]

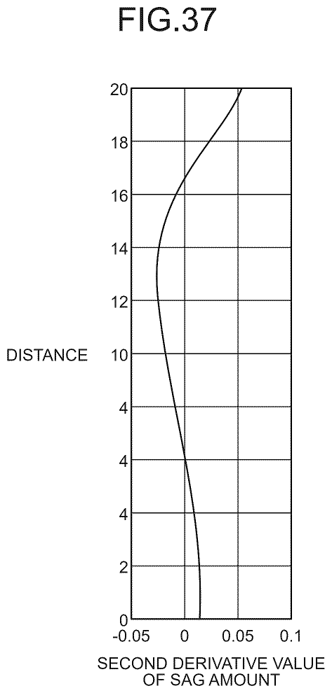

FIG. 37 is a diagram illustrating an exemplary configuration of the first aspherical lens according to the seventh embodiment of the present disclosure. This figure, similar to the right view of FIG. 2A, is a graph illustrating the relationship between the position (h) of the first aspherical lens 120 and the second derivative value of the sag amount. As illustrated in the depicted figure, in the first aspherical lens 120, there are two points where the second derivative value of the sag amount is “0”.

### [Shape of Lens]

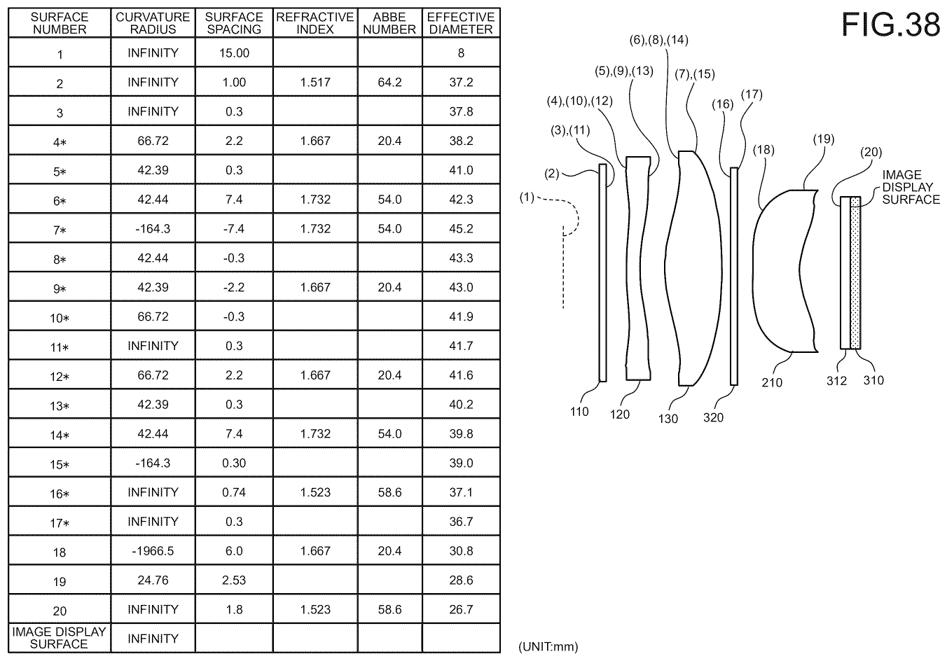

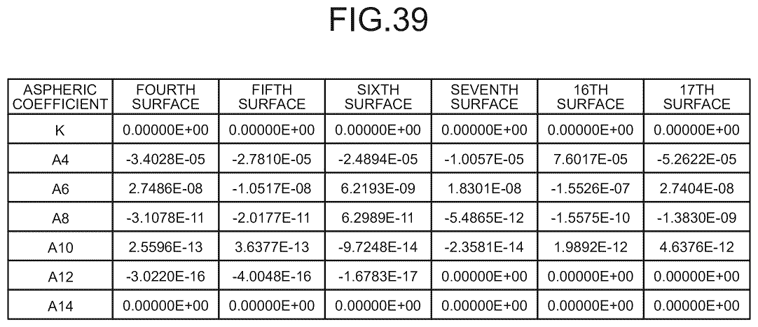

FIGS. 38 and 39 are diagrams illustrating an example of the shape of a lens according to the seventh embodiment of the present disclosure. Similar to FIG. 6, FIG. 38 is a diagram illustrating surface data of the lens of the optical system 10. Further, similar to FIG. 7, FIG. 39 is a diagram illustrating aspheric data of the lens of the optical system 10. The markings in FIGS. 38 and 39 are the same as in FIGS. 6 and 7, respectively. As illustrated in FIG. 38, the refractive index and Abbe number of the first aspherical lens 120 are 1.667 and 20.4, respectively. On the other hand, the refractive index and Abbe number of the second aspherical lens 130 are 1.732 and 54.0, respectively. In this way, the second aspherical lens 130 is configured to have a higher refractive index than the first aspherical lens 120. In addition, the second aspherical lens 130 is configured to have a higher Abbe number than the first aspherical lens 120.

The focal lengths of the first aspherical lens 120 and the second aspherical lens 130 are −180.7 mm and 46.8 mm, respectively. The focal length of the first lens group 100 is 63.7 mm. In addition, the focal length of the aspherical lens 210 of the second lens group 200 is −44.7 mm. This results in f1/f2=1.42.

The focal length, maximum image height, and total angle of view of the optical system 10 are 21.2 mm, 12.1 mm, and 81 degrees, respectively. Moreover, the optical system 10 according to the seventh embodiment of the present disclosure does not assume diopter adjustment.

### [Resolution of Optical System]

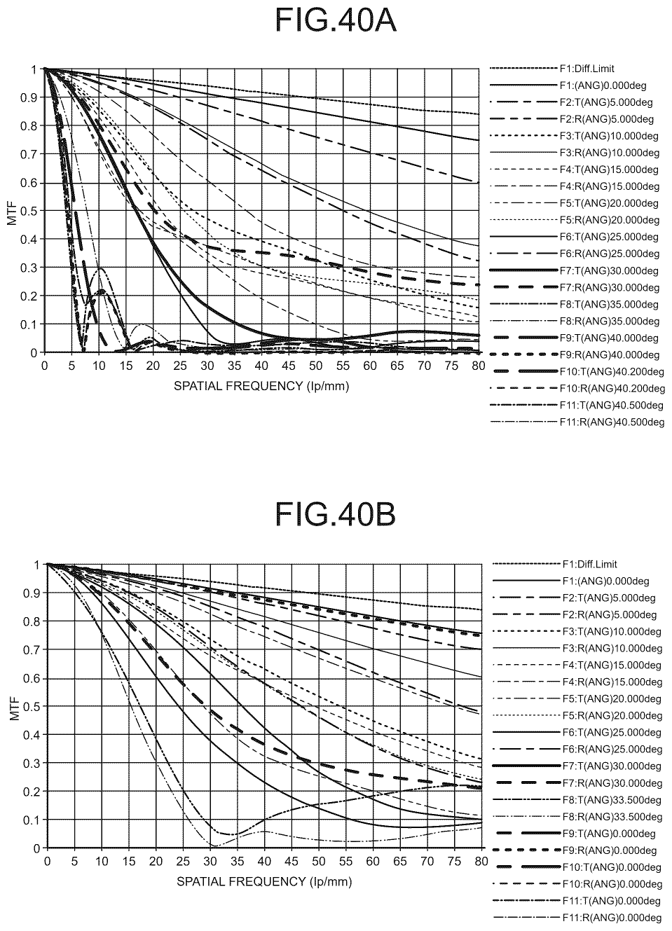

FIGS. 40A and 40B are diagrams illustrating an example of the resolution of the optical system according to the seventh embodiment of the present disclosure. FIG. 40A illustrates the MTF in the case where the eyeball is not rotated, and FIG. 40B illustrates the MTF in the case where the eyeball is rotated. As illustrated in the depicted figure, the MTF in the case where the eyeballs are rotated can be improved.

Moreover, the polarization state-changing unit 326 illustrated in FIG. 36 can also be arranged on the side of the transparent flat plate 320 facing the observation unit 390, similar to FIG. 29. Further, in FIG. 36, it is also possible to employ a configuration in which the first transflective surface 111 is arranged in place of the polarization selection element 115 and the polarization state-changing unit 116 of the transparent element 150, and the polarization state-changing unit 326 and the polarization unit 327 of the transparent flat plate 320 are omitted.

The configuration of the display device 1 other than that described is similar to the configuration of the display device 1 according to the first embodiment of the present disclosure, so the repetitive description will be omitted.

In this way, the optical system 10 according to the seventh embodiment of the present disclosure uses the second aspherical lens 130 having a higher Abbe number than the first aspherical lens 120.

### 8. Eighth Embodiment

### [Configuration of Display Device]

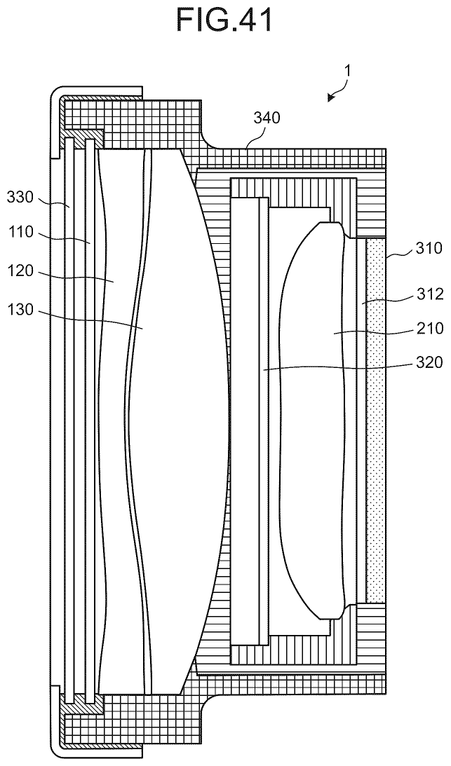

FIG. 41 is a diagram illustrating an exemplary configuration of a display device according to an eighth embodiment of the present disclosure. The depicted figure provides a cross-sectional view illustrating an exemplary configuration of the display device 1. The display device 1 in the depicted figure differs from the display device 1 illustrated in FIG. 1 in that it further includes a housing 340 and a lens protector 330.

Moreover, the glass plate 312 described with reference to FIG. 6 is illustrated for the display element 310 in the depicted figure. This glass plate 312 protects the image display surface 311 of the display element 310.

The housing 340 has a shape that absorbs the light beam reflected by the second transflective surface 131 among the light beams, which are emitted from the image display surface 311 of the display element 310 and reach the second transflective surface 131. Such arrangement of the housing 340 makes it possible to reduce reflected light that reaches the observation unit 390, thereby reducing the occurrence of ghosts.

The configuration of the optical system 10 other than that described above is similar to the configuration of the optical system 10 according to the first embodiment of the present disclosure, so the repetitive description will be omitted.

In this way, the optical system 10 according to the eighth embodiment of the present disclosure is capable of reducing the decrease in the amount of light that reaches the observation unit 390 by arranging the polarization selection element 115 and adjusting the polarization direction of the light incident on the polarization selection element 115.

Moreover, the configuration of the eighth embodiment of the present disclosure is applicable to other embodiments. Specifically, the housing 340 illustrated in FIG. 26 is applicable to the first to seventh embodiments of the present disclosure.

Moreover, the effects described herein are merely examples and are not exclusive, and other effects are also achievable.

Moreover, the present technology can also have the following configuration.

(1)

An optical system for observing an image displayed on an image display surface of a display element from an observation unit, comprising:
a first lens group provided with a transparent element having a first transflective surface, a first aspherical lens, and a second aspherical lens having a second transflective surface, which are arranged sequentially in order from the observation unit, the second transflective surface being formed on a side of the second aspherical lens with a positive refractive power facing the image display surface; and
a second lens group arranged between the first lens group and the image display surface and provided with at least one aspherical lens,
wherein the first aspherical lens has a higher absolute focal length than the second aspherical lens, and
the first aspherical lens has a smaller Abbe number at a d-line than the second aspherical lens.
   (2)

The optical system according to the above (1), wherein the first aspherical lens, at a first surface being a surface of a side closer to the observation unit, has at least one position where a second derivative value with respect to a radial direction of a sag amount becomes zero in a case where the sag amount is positive from the observation unit to the image display surface, the second derivative value at a central portion of the first aspherical lens being a positive value.

(3)

The optical system according to the above (1) or (2), wherein the first aspherical lens is configured to have negative refractive power.

(4)

The optical system according to any one of the above (1) to (3), wherein the second lens group is configured to be adjustable in spacing from the first lens group.

(5)

The optical system according to the above (4), wherein the second lens group is configured to have a focal length that satisfies a conditional expression as follows:

$$- 0.6 < f 1 / f 2 < 0.4$$

where focal lengths of the first lens group and the second lens group are f1 and f2, respectively.
   (6)

The optical system according to the above (4), wherein the second lens group performs refraction in a direction where, of incident light rays from the image display surface, a difference between an angle of incidence of a principal ray in the incident light corresponding to a maximum angle of view and an angle of emergence to the first lens group exceeds 5 degrees.

(7)

The optical system according to any one of the above (1) to (6), wherein the first lens group further includes a third aspherical lens arranged on a side of the second aspherical lens facing the image display surface.

(8)

The optical system according to any one of the above (1) to (7), wherein the second lens group includes an aspherical lens and a second transparent element.

(9)

The optical system according to any one of the above (1) to (7), wherein the second lens group includes a plurality of aspherical lenses.

(10)

The optical system according to any one of the above (1) to (9), further comprising:
a polarization unit arranged between the first lens group and the second lens group to transmit linearly polarized incident light in a specific direction among incident light rays;
a first polarization state-changing unit arranged between the polarization unit and the second aspherical lens to be a polarization state-changing unit configured to change a polarization state of the incident light between linearly polarized light and circularly polarized light; and
a second polarization state-changing unit configured to be as the polarization state-changing unit arranged between the first transflective surface and the second transflective surface,
wherein the first transflective surface includes a polarization selection element configured to reflect one portion of incident light and transmit another portion of incident light, with polarization directions differing by 90 degrees.
   (11)

The optical system according to the above (10), wherein the second polarization state-changing unit is arranged on a third transparent element arranged between the first lens group and the second lens group.

(12)

A display device, comprising:
a display element; and
an optical system configured to observe an image displayed on an image display surface of the display element from an observation unit,
wherein the optical system includes,
a first lens group provided with a transparent element having a first transflective surface, a first aspherical lens, and a second aspherical lens having a second transflective surface, which are arranged sequentially in order from the observation unit, the second transflective surface being formed on a side of the second aspherical lens with a positive refractive power facing the image display surface; and
a second lens group arranged between the first lens group and the image display surface and provided with at least one aspherical lens,
wherein the first aspherical lens has a higher absolute focal length than the second aspherical lens, and
the first aspherical lens has a smaller Abbe number at a d-line than the second aspherical lens.

### REFERENCE SIGNS LIST

1 DISPLAY DEVICE
10 OPTICAL SYSTEM
100 FIRST LENS GROUP
110, 220, 320 TRANSPARENT FLAT PLATE
111 FIRST TRANSFLECTIVE SURFACE
115 POLARIZATION SELECTION ELEMENT
116 POLARIZATION STATE-CHANGING UNIT
120 FIRST ASPHERICAL LENS
130 SECOND ASPHERICAL LENS
131 SECOND TRANSFLECTIVE SURFACE
140 THIRD ASPHERICAL LENS
150 TRANSPARENT ELEMENT
200 SECOND LENS GROUP
210, 230, 240 ASPHERICAL LENS
310 DISPLAY ELEMENT
311 IMAGE DISPLAY SURFACE
326 POLARIZATION STATE-CHANGING UNIT
327 POLARIZATION UNIT
330 LENS PROTECTOR
340 HOUSING
390 OBSERVATION UNIT

1. An optical system for observing an image displayed on an image display surface of a display element from an observation unit, comprising:
a first lens group provided with a transparent element having a first transflective surface, a first aspherical lens, and a second aspherical lens having a second transflective surface, which are arranged sequentially in order from the observation unit, the second transflective surface being formed on a side of the second aspherical lens with a positive refractive power facing the image display surface; and
a second lens group arranged between the first lens group and the image display surface and provided with at least one aspherical lens,
wherein the first aspherical lens has a higher absolute focal length than the second aspherical lens, and
the first aspherical lens has a smaller Abbe number at a d-line than the second aspherical lens.

2. The optical system according to claim 1, wherein the first aspherical lens, at a first surface being a surface of a side closer to the observation unit, has at least one position where a second derivative value with respect to a radial direction of a sag amount becomes zero in a case where the sag amount is positive from the observation unit to the image display surface, the second derivative value at a central portion of the first aspherical lens being a positive value.

3. The optical system according to claim 1, wherein the first aspherical lens is configured to have negative refractive power.

4. The optical system according to claim 1, wherein the second lens group is configured to be adjustable in spacing from the first lens group.

5. The optical system according to claim 4, wherein the second lens group is configured to have a focal length that satisfies a conditional expression as follows:
$$- 0.6 < f 1 / f 2 < 0.4$$
where focal lengths of the first lens group and the second lens group are f1 and f2, respectively.

6. The optical system according to claim 4, wherein the second lens group performs refraction in a direction where, of incident light rays from the image display surface, a difference between an angle of incidence of a principal ray in the incident light corresponding to a maximum angle of view and an angle of emergence to the first lens group exceeds 5 degrees.

7. The optical system according to claim 1, wherein the first lens group further includes a third aspherical lens arranged on a side of the second aspherical lens facing the image display surface.

8. The optical system according to claim 1, wherein the second lens group includes an aspherical lens and a second transparent element.

9. The optical system according to claim 1, wherein the second lens group includes a plurality of aspherical lenses.

10. The optical system according to claim 1, further comprising:
a polarization unit arranged between the first lens group and the second lens group to transmit linearly polarized incident light in a specific direction among incident light rays;
a first polarization state-changing unit arranged between the polarization unit and the second aspherical lens to be a polarization state-changing unit configured to change a polarization state of the incident light between linearly polarized light and circularly polarized light; and
a second polarization state-changing unit configured to be as the polarization state-changing unit arranged between the first transflective surface and the second transflective surface,
wherein the first transflective surface includes a polarization selection element configured to reflect one portion of incident light and transmit another portion of incident light, with polarization directions differing by 90 degrees.

11. The optical system according to claim 10, wherein the second polarization state-changing unit is arranged on a third transparent element arranged between the first lens group and the second lens group.

12. A display device, comprising:
a display element; and
an optical system configured to observe an image displayed on an image display surface of the display element from an observation unit,
wherein the optical system includes,
a first lens group provided with a transparent element having a first transflective surface, a first aspherical lens, and a second aspherical lens having a second transflective surface, which are arranged sequentially in order from the observation unit, the second transflective surface being formed on a side of the second aspherical lens with a positive refractive power facing the image display surface; and
a second lens group arranged between the first lens group and the image display surface and provided with at least one aspherical lens,
wherein the first aspherical lens has a higher absolute focal length than the second aspherical lens, and
the first aspherical lens has a smaller Abbe number at a d-line than the second aspherical lens.
